(19) United States
(12) Patent Application Publication
(10) Pub. No.: US 2026/0141376 A1
(43) Pub. Date: May 21, 2026

(54) ARTIFICIAL INTELLIGENCE BASED SYSTEMS AND METHODS FOR DYNAMICALLY GENERATING USER-SPECIFIC INTERFACES

(71) Applicant: Mastercard International Incorporated, Purchase, NY (US)

(72) Inventors: Devon Santagato, Ballwin, MO (US); Marthom Daetz, Ballwin, MO (US); Nicholas Marchesi, O'Fallon, MO (US)

(21) Appl. No.: 18/955,299

(22) Filed: Nov. 21, 2024

(51) Int. Cl. G06Q 20/34; G06Q 20/20

(52) U.S. Cl. CPC G06Q 20/356; G06Q 20/20

(57) ABSTRACT

A computer system for generating a dynamic checkout flow to a candidate cardholder is provided. The computer system includes a memory device in communication with a processor. The processor is programmed to receive transaction information for a plurality of cardholders from a payment network. The transaction information includes data relating to purchases made by the cardholders at a plurality of merchants. The processor receives candidate cardholder preference information for at least one of the merchants input by the candidate cardholder. The computer system determines cardholder preferences for each merchant based on the received transaction information, and determines and implements a customized checkout user interface during a purchase based on the received transaction information and cardholder preferences. The computer system also builds a cardholder-specific model that is trained and updated over time using the transaction information and cardholder preferences, the cardholder-specific model assisting in generating the customized checkout interface.

### BACKGROUND OF THE DISCLOSURE

The field of the disclosure relates generally to artificial intelligence based systems and methods for dynamically generating user-specific interfaces and, more particularly, to systems and methods that utilize artificial intelligence tools to dynamically adjust user interfaces displayed on a user device based at least in part on (i) the user's preferences when interacting with an online portal, and/or (ii) the preferences of third-parties associated with online portals.

In today's computer world, people regularly interact with computer systems via online portals. In some cases, this interaction includes a consumer interacting with a website or a computer app of a merchant. In other cases, it may be patient or a customer interacting with a website or app of a medical provider or financial institution. These user interactions may result in different user experiences. In some cases, the experience may be positive for the user which may then likely result in the user interacting with that website or computer app again. However, in some cases, the experience may not be positive, and thus, the user may not want to use that website or app again. A positive user experience when using a website and/or computer app is important for retaining business.

For example, consumers today are frequently interacting with websites, merchant computer apps and/or in-store terminals that include display screens that are capable of displaying information. These interactions may include online shopping, retrieving certain consumer information, and/or initiating purchases (e.g., checkouts). It is important to the merchants that these interactions be smooth and enjoyable for the consumer. However, not every consumer likes the same thing. This is true for online experiences too. Accordingly, it is difficult for merchants to provide a positive user experience for all users including a meaningful and inclusive checkout experience that is directed to the general consumer.

Consumers are now able to make purchases using a variety of different payment devices. For example, card-based purchases include purchases made with physical credit or debit card(s) (e.g., swiped, tapped, or inserted at an in-store payment terminal), as well as purchases made via payment platforms and/or digital wallets that are linked to the credit card(s), and/or by using other digital versions of the credit card(s) that may be available for use in transactions (e.g., certain card issuers may provide a “digital” version of a physical credit card). Online purchases may be made using mobile terminals such as mobile phones and other smart devices (e.g., tablets), as well as by using more traditional computing terminals such as laptop and/or desktop computers. Online purchases may be made using websites including desktop and mobile versions of websites, as well as purchases made through a merchant's application, such as an application that is downloadable from common application download stores accessible via mobile phone operating systems. Such mobile applications (e.g., “apps”) may be provided by brick-and-mortar merchants, online-only merchants, or other consumer industries that may use surrogate physical locations for conducting business, such as online gambling. Accordingly, different consumers may like to use different payment methods when making purchases. Checkout experiences need to accommodate these different payment methods.

Additionally, it is now common for consumers to make purchases using other devices or technologies and user interfaces of such devices/technologies when making purchases including (i) via interactive chatbots, (ii) within a user interface of a video game (e.g., in-game purchases), (iii) within a user interface of a television (e.g., via the operating system of the television, “apps” installed on the television system, or other options such as digital video (e.g., VOD) rentals/purchases services), (iv) within a user interface of headset devices such as virtual reality (VR) headsets and/or smart glasses, and (v) via digital voice assistant devices (e.g., devices that interact primarily through voice recognition and voice communication). These additional forms of purchase may be referred to herein as “digital transactions.”

For example, interactive chatbots may be present in or on a merchant's desktop website, mobile website, and/or mobile application. Merchants may create a checkout experience that is intended to provide a consistent experience across different checkout interfaces, be it via computer terminals (e.g., the checkout process on a mobile phone being substantially similar to a checkout experience on a web-browser of a desktop computer), in-store payment terminals, and/or checkout interfaces presented in alternative (e.g., digital) formats such as in chatbots, video games, and other technology devices and digital store services that provide for the purchase of goods/services as discussed above. For example, the ability to purchase may be implemented as part of a transaction (e.g., checkout) process on any type of interactive display screen and/or other means of purchasing, such as an oral command provided by a user to a smart home voice assistant device that may be linked to one or more of a user's merchant accounts and/or credit cards.

However, even when the checkout experience is largely consistent across a variety of devices, the checkout experience may still not be optimized or individualized for a particular user (e.g., consumer) accessing the website or other purchase portal. To address these issues, various known methods exist that provide more convenient, tailored checkout experiences to consumers when checking out either in-store or in particular when using a website of an online merchant. For example, online merchants may store a user's profile including payment information and past purchases, and/or may allow for payment to be made via digital wallets and/or other payment platforms so that the user does not have to enter in their detailed payment information (e.g., name, address, credit card number), each time they make a purchase.

However, these known systems for streamlining the checkout process still fail to address many of the problems that consumers experience. For example, these known systems do not allow online merchants to quickly be able to change their checkout flows, for example during a mid-checkout experience, to tailor the checkout interface for the particular user. Moreover, these known systems do not allow a merchant to dynamically change a checkout flow to ensure that multiple desired sales outcomes are presented to the consumer. By only providing predefined checkout flows to all users in general, merchants are unable to cater to a user's particular preferences and/or each user's individual understanding of user interfaces, which can lead to abandoned online shopping carts and other missed (e.g., sales) opportunities for a percentage of the potential buyers using online merchant websites for purchases. Additionally, due to the lack of optimization/personalization for each individual user, opportunities to offer other products specific to the user and/or notify users of related goods/services that they may be interested in are missed. Moreover, opportunities to build on a user's loyalty to the merchant may be missed by not optimizing/personalizing the checkout process for individual users. Other failures and missing features may also be part of these known systems.

### BRIEF DESCRIPTION OF THE DISCLOSURE

In one embodiment, a computer system for providing a dynamic purchase experience to a candidate cardholder, the computer system including at least one memory device for storing data and at least one processor in communication with the at least one memory device. The at least one processor programmed to: (a) receive current transaction data of the candidate cardholder from a current transaction of the candidate cardholder at a candidate merchant, the candidate merchant being part of a plurality of merchants; (b) process the current transaction data to generate a plurality of candidate parameters; (c) retrieve merchant instructions defining a plurality of merchant parameters, the plurality of merchant parameters being associated with a plurality of transaction processes; (d) compare the plurality of candidate parameters and the plurality of merchant parameters to a plurality of model parameters of a purchase model, the purchase model being specific to and associated with the candidate cardholder; (e) identify a parameter association between (i) any of the plurality of candidate parameters, (ii) any of the plurality of merchant parameters, and (ii) any of the plurality of model parameters; (f) generate, based on the parameter association, a set of user interface instructions; and (g) cause, via a computing device associated with the candidate cardholder, a model-defined user interface relating to the parameter association to be presented to the candidate cardholder during the current transaction via a display screen of the computing device, the model-defined user interface being defined by the user interface instructions.

In another embodiment, a computer-implemented method for providing a dynamic purchase experience to a candidate cardholder using at least one processor in communication with at least one memory, the method including: (a) receiving current transaction data of the candidate cardholder from a current transaction of the candidate cardholder at a candidate merchant, the candidate merchant being part of a plurality of merchants; (b) processing the current transaction data to generate a plurality of candidate parameters; (c) retrieving merchant instructions defining a plurality of merchant parameters, the plurality of merchant parameters being associated with a plurality of transaction processes; (d) comparing the plurality of candidate parameters and the plurality of merchant parameters to a plurality of model parameters of a purchase model, the purchase model being specific to and associated with the candidate cardholder; (e) identifying a parameter association between (i) any of the plurality of candidate parameters, (ii) any of the plurality of merchant parameters, and (ii) any of the plurality of model parameters; (f) generating, based on the parameter association, a set of user interface instructions; and (g) causing, via a computing device associated with the candidate cardholder, a model-defined user interface relating to the parameter association to be presented to the candidate cardholder during the current transaction via a display screen of the computing device, the model-defined user interface being defined by the user interface instructions.

In yet another embodiment, one or more non-transitory computer-readable storage media with instructions stored thereon that, in response to being executed, cause a computer system for providing a dynamic purchase experience to a candidate cardholder to: (a) receive current transaction data of the candidate cardholder from a current transaction of the candidate cardholder at a candidate merchant, the candidate merchant being part of a plurality of merchants; (b) process the current transaction data to generate a plurality of candidate parameters; (c) retrieve merchant instructions defining a plurality of merchant parameters, the plurality of merchant parameters being associated with a plurality of transaction processes; (d) compare the plurality of candidate parameters and the plurality of merchant parameters to a plurality of model parameters of a purchase model, the purchase model being specific to and associated with the candidate cardholder; (e) identify a parameter association between (i) any of the plurality of candidate parameters, (ii) any of the plurality of merchant parameters, and (ii) any of the plurality of model parameters; (f) generate, based on the parameter association, a set of user interface instructions; and (g) cause, via a computing device associated with the candidate cardholder, a model-defined user interface relating to the parameter association to be presented to the candidate cardholder during the current transaction via a display screen of the computing device, the model-defined user interface being defined by the user interface instructions.

### BRIEF DESCRIPTION OF THE DRAWINGS

FIGS. 1-19 show exemplary embodiments of the methods and systems described herein.

FIG. 1 is a schematic diagram illustrating an example multi-party payment processing system for enabling payment transactions used in conjunction with a dynamic checkout flow (DCF) computing system for dynamically adjusting user interfaces in accordance with one embodiment of the present disclosure.

FIG. 2 is a block diagram of an example embodiment of a dynamic checkout flow (DCF) platform including the DCF computing system shown in FIG. 1.

FIG. 3A is a data flow diagram showing an example data flow of the DCF platform of FIG. 2.

FIG. 3B is a data flow diagram showing an example data flow for a specific transaction type (e.g., online store) within the data flow diagram shown in FIG. 3A.

FIG. 3C is a data flow diagram showing an example data flow for a specific transaction type (e.g., point-of-sale (POS) terminal) within the data flow diagram shown in FIG. 3A.

FIG. 3D is a data flow diagram showing an example data flow for a specific transaction type (e.g., mobile application) within the data flow diagram shown in FIG. 3A.

FIG. 4 is an example configuration of a client computing device shown in FIG. 2.

FIG. 5 is an example configuration of a server computing device shown in FIG. 2.

FIG. 6 is a diagram of components of one or more example computing devices that may be used in the DCF platform shown in FIG. 2.

FIG. 7 is a process flow diagram showing an example method for generating a dynamic checkout flow using the DCF system of FIG. 1.

FIG. 8 is a process flow diagram of an example method for generating a user model using the DCF system of FIG. 1.

FIG. 9 is an illustration of an example user interface of a merchant online store shown in FIG. 3B, that may be used by a cardholder to interface with the DCF platform shown in FIG. 2.

FIG. 10 is an illustration of an example modified user interface of an online store such as shown in FIG. 9, showing a user interface modified by the DCF system that may be used by a consumer to interface with the DCF platform shown in FIG. 2.

FIG. 11 is an illustration of an example modified user interface of an online store such as shown in FIG. 9 or FIG. 10, showing a user interface modified by the DCF system that may be used by a consumer to interface with the DCF platform shown in FIG. 2.

FIG. 12 is an illustration of an example modified user interface of a mobile application shown in FIG. 3D that may be used by a consumer to interface with the DCF platform shown in FIG. 2.

FIG. 13 is an illustration of an example alternate modified user interface of a mobile application such as shown in FIG. 3D that may be used by a consumer to interface with the DCF platform shown in FIG. 2.

FIG. 14 is an illustration of an example modified user interface of a POS terminal shown in FIG. 3C that may be used by a consumer to interface with the DCF platform shown in FIG. 2.

FIG. 15 is an illustration of an example alternate modified user interface of a mobile application such as shown in FIG. 3C that may be used by a consumer to interface with the DCF platform shown in FIG. 2.

FIG. 16 is a component diagram of a deep learning device of a deep learning system of the DCF computing system shown in FIGS. 1 and 2 in one example embodiment.

FIG. 17 is a flow chart illustrating various operating components of a neural recommender model trained and implemented by the deep learning device in the deep learning system.

FIG. 18 is a data flow diagram illustrating a process and associated data for identifying target cardholders to receive offers from a particular category.

FIG. 19 is a data flow diagram illustrating a process and associated data for identifying merchants or categories which a cardholder may like when in a different location (e.g., while traveling).

Like numbers in the Figures indicate the same or functionally similar components. Although specific features of various embodiments may be shown in some figures and not in others, this is for convenience only. Any feature of any figure may be referenced and/or claimed in combination with any feature of any other figure.

### DETAILED DESCRIPTION OF THE DISCLOSURE

The following detailed description illustrates embodiments of the present disclosure by way of example and not by way of limitation. The description enables one skilled in the art to make and use the disclosure, describes several embodiments, adaptations, variations, alternatives, and uses of the disclosure, including what is presently believed to be the best mode of carrying out the disclosure. The disclosure is described as applied to an example embodiment, namely, methods and systems for providing consumers with individualized user interfaces when purchasing goods and/or services (collectively referred to as “items”).

More specifically, the disclosure describes a dynamic checkout flow (DCF) feature that may be provided by a DCF provider and implemented as a service using a DCF system that can be integrated into a plurality of connected computer systems that provide for the purchasing of items. For example, the DCF provider may charge a fee for participants to use the DCF service. The DCF system may be implemented in or on each of computer systems providing (i) a merchant's checkout experience, (ii) a payment service provider's checkout experience, and/or (iii) a DCF provider's checkout experience. The DCF system may actively track a consumer's (e.g., payer's) buying behaviors based on their interactions with the user interfaces provided to them during respective checkout experiences and/or during usage of a website or other portal providing a checkout experience(s).

As used above and herein, a DCF provider may include the manufacturer/producer/creator/owner/operator of the DCF computing system, wherein operation of the DCF computing system includes the DCF computing system providing a DCF service (described below in more detail), whereas “providers” alone may refer to providers of other items, such as merchants, payment service providers, and/or the DCF provider. Additionally, a consumer may be referred to as a user (e.g., end user), a payer, a purchaser, a cardholder, and vice versa for each.

In an example embodiment, the DCF service may be implemented as computer code of (i) a checkout process (e.g., consumer-facing and/or back-end), (ii) a device (e.g., of a merchant and/or of a consumer), and/or (iii) other software such as an application (e.g., a mobile application which may be present on any variety of computing devices such as mobile phones). For example, the DCF service may be implemented as computer code (including but not limited to a software plugin) so that the DCF service can be used in many forms such as in or on desktop/mobile browsers, mobile apps, virtual reality devices, in-person checkout terminals, interactive chatbots, and/or gaming systems and video games (e.g., in digital storefronts provided within a game console's software and/or digital storefronts provided with an individual video game's software).

The DCF system may include and utilize artificial intelligence (AI) software architecture and tools, such as in the form of machine learning (ML), to learn and/or implement (i) a customer's shopping behaviors and preferences, (ii) sales goals and/or other business objectives of a merchant, and/or (iii) any other pertinent data, information, rules, parameters, and/or guidelines generally relating, for example, to the purchase, sale, and/or providing of items. The learned preferences/behaviors of the consumer and the goals/objectives of the merchant may be used together by the AI/ML architecture of the DCF service to, for example, best estimate and adapt user interface (UI) components in a way that provides a checkout experience that is personalized and may increase the chance that certain purchase outcomes desired by the merchant and possible other secondary entities occur. Such outcomes include but are not limited to: increasing the chances that a consumer completes an entire checkout flow (e.g., does not abandon their online shopping cart); providing additional items for sale within the checkout flow that are customized to the consumer (e.g., a consumer is presented with and buys an additional item (e.g., add-on) item during checkout); and more generally gathering a plurality of user and/or merchant information for better training of the AI/ML models of the DCF system, and providing additional authentication and/or fraud prevention measures during the checkout experience.

The present disclosure describes a deep learning system of the DCF computing system, and associated devices and methods, that apply several deep learning techniques in the context of user or consumer or cardholder interactions with merchants via payment transactions and payment card transaction data to provide a DCF service capable of learning user behaviors and preferences and applying such learned behaviors and preferences to provide a customized user experience (e.g., at checkout) tailored to a particular user. In one example embodiment, the deep learning system applies neural collaborative filtering (NCF) with such data to generate a model that is configured to predict interactions between consumers and particular merchants. This NCF technique combines aspects of the techniques of generalized matrix factorization (GMF) with a multilayer perceptron (MLP) to generate a deep learning system that can provide improved predictions of checkout flows for cardholders. During model build, the deep learning system focuses on a few pre-defined sliding features and custom overlap features (e.g., users identifying column names from data sources) such that efforts to pre-compute lifetime value (LTV) are reduced. The deep learning system generates exponential growth of hidden embedding features, effectively performing internal feature selections and optimization automatically (e.g., during cross validation at the training stage), thereby improving the ability to find optimal features and handle indirect relationships between features and goals.

In the example embodiment, the DCF system is implemented by providing a for-sale service to be offered/provided to merchants (e.g., a merchant or other participating entity would pay DCF provider a certain fee for partaking in and/or having access to the DCF platform). A merchant may provide their user interface (UI) components (e.g., components used as part of their checkout process) to the DCF system in order to take advantage of the benefits provided by the DCF service. These UI components may include, for example, various user interface and other components (e.g., graphics, prompts) used on the merchant's websites, apps, etc. during a checkout process (including both front-facing and backend components). Additional example usages and benefits of the DCF service to payers and merchants are provided below.

As provided herein, the DCF system for providing and operating the DCF service may include a computer system that includes a merchant's computer system, a payment service provider's computer system (or payment processor), and/or a DCF provider's computer system interconnected in a manner so as to allow for the collection (e.g., over time) and transfer of data associated with a variety of events and other happenings relating generally to purchases, sales, and offers to sell. This includes, in the case of a payment card user (e.g., cardholder), cardholder payments, cardholder preferences, and using the DCF service to dynamically adjust a checkout flow based on learned cardholder factors (e.g., purchase factors). The DCF service may also be utilized for purchasers that do not use payment cards or payment card ecosystems, and instead use cash (e.g., in in-store settings). For example, if the purchaser can be otherwise identified (e.g., without using a payment card), the DCF service can be triggered, and the DCF service can be utilized. For example, an in-store purchaser using cash may still be able to be identified by the merchant if the purchaser swipes a loyalty program card or enters other loyalty account information during the in-store purchase, where such loyalty information may be specific to that particular merchant and usable by the DCF service. The DCF service is intended to, as best possible through learned behaviors, ensure the highest user comfortability and check out rates in a variety of purchase settings.

In the example embodiment, the DCF system for providing and operating the DCF service may include a computer system that includes a merchant's computer system, a payment service provider's computer system, and/or a DCF provider's computer system. Each computer system includes at least one memory device and at least one processor in communication with the memory device(s) and is/are programmed to communicate with the other systems and any related communication and/or computer networks such as a payment network to receive transaction information for a plurality of purchasers. For example, the payment network is able to process payment card transactions between the merchant and its acquirer bank, and the cardholder and their issuer bank. Transaction information includes data relating to purchases made by purchasers (e.g., cardholders) at various merchants during, for example, a predetermined time period and within a predetermined geographical region.

More specifically, the DCF system for providing the DCF service includes a computer system that may be realized in a multi-system computer (e.g., computer sub-system, or just sub-system) implementation. For example, the DCF service may include three main sub-systems: (i) a computer sub-system on the end user's local device or application (“device sub-system” or “user sub-system”); (ii) a computer sub-system on the merchant's side (“merchant sub-system”); and/or (iii) a computer sub-system on the DCF provider's server side (“DCF provider sub-system”). Because the DCF provider sub-system may provide interface control and/or otherwise directly interact with the device and merchant sub-systems, the DCF provider sub-system may be viewed as the controlling sub-system of the three sub-systems. For example, the DCF product provider is the provider (e.g., creator/purveyor/producer) of the DCF service and may control the DCF service on the DCF provider's server side or grant authority for such control to another party, such as a white-labeled third party.

The DCF service, in the example embodiment, may include computer code (e.g., code for implementing the DCF service or DCF code) that the provider (e.g., the creator of the code) provides to merchants, partners, and/or other payment facilitators to implement the DCF service. In the device and merchant sub-systems, the associated device and merchant entities each can define all of their respective checkout user interface components with the code for the provider sub-system to utilize in resulting checkout flows. For example, the DCF code would be implemented within a partner's code for their desired platform (e.g., the merchant sub-system) or for device manufacturers/application creators (e.g., the device sub-system). The merchant entities associated with the merchant sub-systems may have the ability via the DCF code to define their preferred respective outcomes. These outcomes may include users completing an entire checkout flow (e.g., no abandoned carts when online shopping), offering and selling additional items specific to the consumer during the checkout flow (e.g., online, in-store, or in-app), and/or gathering user (e.g., payer) information.

When a payer uses that particular merchant's or device manufacturer's platform, the DCF code will track the user's interaction with the user interfaces presented and log those interactions against an individual customer profile stored on the product provider's end in the provider sub-system. This data may be used to train and/or update a variety of AI/ML models of the DCF computing system, for consumers at-large and/or individualized models at an individual user level. The checkout experiences that utilize the DCF code are then presented dynamically to the end user based on the determinations resulting from the learned end user behavior via the applied AI/ML tools (e.g., calculated on the DCF provider's system as described below in more detail). Preferences consistent with the payer's current and/or prior interactions may be presented in accordance with the desired outcomes of the device and/or merchant partners. The DCF provider sub-system may consider multiple desired outcomes with different priorities (e.g., different hierarchies, using ranks and/or weighting, for example). This may include an outcome prioritization process to be decided by the device and/or merchant partner on a case-by-case basis. If there are competing outcomes requested from the device and merchant sub-systems, the DCF provider sub-system may prioritize the outcomes on a case-by-case basis.

The total system (e.g., including at least all three sub-systems) works best when all three sub-systems are used in tandem, but if the device and/or merchant sub-systems are missing or otherwise unavailable, the DCF service would still be capable of performing the intended tasks and providing corresponding outputs, although there may a less tailored experience for the end user as compared to when all three sub-systems are used in tandem (e.g., in harmony). For example, with respect to the device sub-system, some devices or applications may not always be online, and this sub-system may be able to log offline user behavior and “check-in” when network connectivity becomes available. The payer's checkout behaviors will be tracked in a similar manner as a web browser cookie performs tracking (e.g., across various providers that are using the DCF service). This promotes an increased tailored experience across all websites and devices enlisted in the DCF service.

In one embodiment, the AI/ML architecture may be utilized to build user-specific models that are trained and updated (e.g., with new transaction data), for use in customizing and modifying a plurality of aspects of the checkout process according to learned preferences and/or behaviors of a specific user. For example, a checkout page or portal associated with the checkout process may be customized and/or modified by AI/ML to help avoid abandonment by the consumer of the items included in a virtual “shopping cart” associated with the checkout process. More specifically, ML may be utilized to customize and modify aspects of the checkout process in real-time, such as the checkout page or portal, after learning preferred user patterns for checkouts. The usage of AI/ML allows for continuous acquiring of data of a user or a group of users, and analyzing the acquired data to provide modified user interfaces, recommendations, and offers to users to enhance checkout experiences, and to aid in preventing abandonment of an online purchase. AI/ML may also be utilized in connection with providing a preferred payment experience based on past user behavior, including determining which types of additional and/or subsequent purchase services the user responds best to along with how and when they might best respond. For example, for a user that frequently abandons their shopping carts when shopping on their mobile device, but does not tend to abandon their shopping carts when using their desktop computer, the AI/ML architecture of the DCF platform may present the user, on the mobile phone interface, with an option to shift from completing the checkout process on their mobile phone to their desktop computer, which may result in an increase in completed purchases (e.g., a decrease in abandoned carts).

The DCF computer system can be used in conjunction with other purchase aspects as well. For example, additional and/or subsequent purchase services commonly include, but are not limited to, sending a post-transaction email after a purchase is made and/or after adding items to an online shopping cart (e.g., a follow-up email), and/or providing additional assistance (e.g., Q&A prompts or other follow-up survey questions and the like) during or after checkout (e.g., regardless of if the user is shopping online, in-person, or in a digital environment such as playing a video game, interacting with a chatbot, and similar digital environments). The DCF computer system can learn the user's response to these other tools and implement them into the user model.

While the data acquisition and analysis described herein would be greatly aided by AI/ML, the core tasks herein can also be performed without the use of AI/ML, or the AI/ML aspects may be complemented and/or supplemented by other machine review and input (e.g., to adjust or otherwise account for inaccuracies, bias, etc.) in the models). For example, output of the AI/ML software may be further reviewed and corrective instructions or other adjustments to improve the ability of the AI/ML software to more accurately profile user behavior may be applied. This additional layer of review and updating of any algorithms and/or models associated with the AI/ML software may help to reduce and/or avoid so-called AI “hallucinations,” AI bias, and/or other undesired outputs from the AI/ML software. This increases the accuracy of the tailored checkout experience and the odds that a merchant's goals or other objectives will be met. For example, the AI/ML software may be particularly helpful in determining an individualized user interface for non-traditional or “fringe” purchasers (e.g., 3-5% of total purchasers).

In one embodiment, the DCF code of the DCF service is deployed as a tool in the form of a software plugin (e.g., DCF plugin) to provide functionality and data collection across a variety of participating entities. The DCF provider (e.g., the producer of the DCF plugin) provides the DCF plugin to merchants, partners, and/or other payment facilitators as applicable. For example, a merchant can install the plugin as a feature in their online store (e.g., website) or in their mobile application. Additionally, or alternatively, a purchaser could install a DCF plugin in their own web browser, such plugin capable of tracking the user across a variety of websites (e.g., any website, or websites of merchant and other partners that participate in the DCF platform) and reporting user behavior across the various websites to the DCF provider.

In one embodiment, for cardholders that transact at one or more merchants of a plurality of merchants, sometimes referred to herein as a candidate merchant, associated with the DCF platform during a predetermined time period, the DCF computing system creates a profile of the cardholder and tracks and learns the behavior and preferences of the cardholder, all while having been coded to operate a merchant UI according to a set of rules defined by the merchant. These rules may include any variety of general rules, but also periodic rules relating, for example, to current sales and/or business goals and/or objectives of the merchant (e.g., quarterly sales goals). For example, the DCF service may be coded for a particular time frame to emphasize sales volume over high-dollar purchases, and the merchant UI may be coded to emphasize such a goal in a dynamic manner based on the characteristics of any desired checkout flow configuration. For each cardholder that has transacted at multiple merchants within the specified time segment, the DCF computing system updates the cardholder profile and, using the AI/ML software, learns and improves over time to be able to better dynamically adjust the UI presentation to the cardholder, while taking into account the merchant's current goals. More specifically, the AI/ML software of the DCF service ingests all pertinent purchase data, creating more and more valuable and accurate profiles over time.

The systems and methods disclosed herein provide a variety of benefits to all users of the DCF ecosystem. With respect to payers (e.g., consumers), an example of a payer benefit includes: if a payer generally responds well to receiving a follow-up email after their purchase, this preference would be learned by the DCF service and the DCF service would know to present the particular payer with a follow-up email after checkout. However, if that same payer is determined to respond better to another option, such as an option to simplify a UI interface of the checkout experience right then and there at the time of checkout, the DCF service will provide that option instead of (or in addition to) the follow-up email. A simplified user interface may be an interface that presents a user with fewer options than a standard interface, such as fewer graphics, fewer fields, etc. For example, the DCF service may learn that while the payer responds well to a follow-up email, the payer also wants a checkout page that has minimal graphics on the page, and will thus implement a reduced-graphics UI for that particular payer. Another example of a payer benefit includes: if a payer is having trouble logging into their merchant-managed user account, the DCF service can automatically provide a simplified and tailored checkout experience, for example by relying on authentication means other than the (e.g., username/password) credentials of the payer's merchant-managed user account. For example, the DCF service could instead send the payer an email link to complete the purchase, and/or use two-factor authentication (2FA). More generally, the DCF service will optimize the components for accessibility on the fly in a way that is catered to the payer's accessibility needs. These non-limiting examples show how the payer may benefit from the DCF service by way of a checkout experience that is increasingly catered to all specific and individual needs of the payer. Any user transaction data, preferences, and/or behaviors may be referred to as factors (e.g., purchase/purchaser factors). Transaction data may be referred to a purchase activity data.

Merchants also realize a host of benefits from the DCF service. One example of a merchant benefit includes: the merchant may benefit from the DCF service by way of increased retention of customers due to the DCF service providing a tailored user experience based on an individual user's preferences. Another example of a merchant benefit includes: the DCF service may result in reduced abandoned carts due to increased consumer retention achieved by way of the DCF service learning more individualized information about the consumer.

Additionally, and for example, the DCF service may provide fraud benefits useful to all parties. For example, the DCF service can track end user behavior to better understand high-risk behaviors in order to incorporate and implement risk-analyzing services dynamically via the DCF service. This may include, for example, triggering a fraud alert if the DCF service detects that a user's behavior is far outside of their typical pattern based on a comparison to that user's individual DCF model. For example, if a user's cart on a merchant website experiences a rapid addition of a large volume of goods to a cart in a manner that is inconsistent with any prior learned data from that particular user, a fraud alert would be triggered. More generally, behavior that is inconsistent with or otherwise suspicious to that learned by the DCF service for a particular user may be utilized in dynamic fraud detection, prevention, and/or mitigation efforts via the DCF service. Another example of an event that may trigger a fraud review is when, for example, a husband logs into an account of the husband, but does so on his wife's phone. This may be detected as abnormal behavior, and the DCF computing system may then takes steps, based on (e.g., merchant) rules stored in the system, to adjust the interface to account for the abnormal activity. This may entail adjusting the interface to require the user to provide authentication or other identity validation.

A technical effect of the systems and methods described herein is achieved by performing at least one of the following steps: (a) dynamically updating plural aspects of a candidate merchant's (or plurality of merchants) checkout process(es) and user interfaces, including but not limited to, presenting dynamic user interfaces to a consumer at checkout, dynamically presenting upsell items to the consumer during checkout, and providing dynamic authentication options to the consumer during checkout, each of these dynamic aspects being tailored to the particular user based on the learned behavior and/or preferences of the particular user; (b) receiving, by the DCF computer system, transaction information for a plurality of cardholders from a payment network, wherein the transaction information includes data relating to purchases made by the plurality of cardholders at a plurality of merchants during a predetermined time period and within a predetermined geographical region (or some other criteria); (c) receiving, from a candidate cardholder included within a plurality of cardholders, candidate cardholder behavior and preference information for one or more merchants of the plurality of merchants, the candidate cardholder preference information obtained from use of purchase interfaces on a cardholder computing device(s); (d) based on acquired transaction, behavior, and/or preference information, creating, via AI/ML software and techniques of the DCF computing system, dynamic user profiles and updating the dynamic user profiles over time with new transaction information of the user to increase the accuracy of the user profiles over time, thereby improving purchase experiences of the cardholder; (e) applying the candidate cardholder dynamic user profile to adjust a user interface of a checkout flow of a merchant; and (f) based on the applied candidate cardholder dynamic user profile, implementing a dynamic checkout flow process for the candidate cardholder. More generally, a technical effect of the systems and methods described herein is improvements in user interfaces, payment systems, and automated profiling of consumer preferences.

Additional benefits to those already disclosed include, for example, benefits to entities that own a payment service provider and are involved in checkout services. The DCF service provides for enhancing a checkout experience with accessibility in mind, optimization for (e.g., non-traditional) consumers, and enhancement of the overall checkout experience for merchants, platform owners, payment facilitators, and payers alike. For example, non-traditional users may be considered to make up roughly 3-5% of total purchasers and are typically overlooked. The DCF service disclosed herein can be utilized so that such fringe users are no longer overlooked.

As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a prepaid card, a gift card, and/or any other device that may hold payment account information, such as mobile phones, smartphones, personal digital assistants (PDAs), key fobs, and/or computers, without limitation. Each type of transactions card can be used as a method of payment for performing a transaction.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

As used herein, “machine learning” refers to statistical techniques to give computer systems the ability to “learn” (e.g., progressively improve performance on a specific task) with data, without being explicitly programmed for that specific task. The terms “neural network” (NN) and “artificial neural network” (ANN), used interchangeably herein, refer to a type of machine learning in which a network of nodes and edges is constructed that can be used to predict a set of outputs given a set of inputs.

In one embodiment, a computer program is provided, and the program is embodied on a computer readable medium. In an exemplary embodiment, the system is executed on a single computer system, without requiring a connection to a sever computer. In a further exemplary embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of AT&T located in New York, New York). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

The following detailed description illustrates embodiments of the disclosure by way of example and not by way of limitation. It is contemplated that the disclosure has general application to processing financial transaction data by a third party in industrial, commercial, and residential applications.

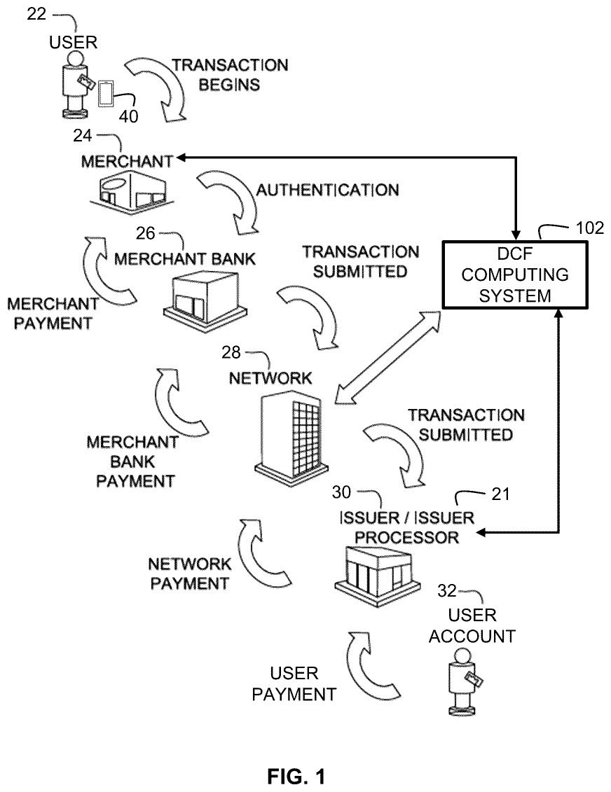

FIG. 1 illustrates a schematic diagram of an example multi-party payment account system for enabling payment transactions initiated by users 22 (also referred to herein as cardholders, purchasers, and/or consumers) over a payment processing network 28 that is in communication and used in conjunction with a dynamic checkout flow (DCF) computing system 102. As described below in more detail, DCF computing system 102 is configured to collect data from a merchant 24 (e.g., transaction data, operations data) and use AI/ML architecture (e.g., software) to learn patterns and other insights from the collected data and apply the learned patterns and insights to improve a service function (“DCF service”) performed and provided by the DCF computing system 102. DCF computing system 102 is further configured to perform other functions, including a function to authenticate user 22 through the use of an authentication protocol, and, once user 22 has been authenticated, transmit an authentication message to payment processing network 28 (e.g., an interchange network) for further processing of the transaction.

Embodiments described herein may relate to a transaction card system, such as a payment card payment system using the Mastercard interchange network and/or third party payment processing systems and networks. The Mastercard interchange network is a set of proprietary communications standards promulgated by Mastercard International Incorporated for the exchange of financial transaction data and the settlement of funds between financial institutions that are members of Mastercard International Incorporated. (Mastercard is a registered trademark of Mastercard International Incorporated located in Purchase, N.Y.). In the exemplary embodiment, DCF computing system 102 is communicatively coupled to merchant 24, payment processing network 28, and an issuer 30. As used herein, merchant 24 and issuer 30 may be directly connected to DCF computing system 102, or may be indirectly connected to DCF computing system 102 through payment processing network 28.

In the example embodiment, a financial institution called the “issuer” or “issuing bank” issues an account, such as a credit card account, a debit account, or a prepaid card account to user 22 (e.g., cardholder 22), who uses the account to tender payment for a purchase from a merchant 24. In one embodiment, cardholder 22 presents a payment card and/or a digital wallet to merchant 24 using a user computing device (also known as card-present transactions). In another embodiment, the user does not present a physical payment device, and instead performs a card-not-present transaction. For example, the card-not-present transaction may be initiated via a digital wallet application, through a website or web portal, via telephone, or any other method that does not require the user to present a physical payment card to merchant 24 (e.g., via swiping or inserting the payment card and/or scanning the digital wallet).

To accept payment with the transaction card, merchant 24 establishes an account with a financial institution that is part of the financial payment system. This financial institution is usually called the “merchant bank,” the “acquiring bank,” or the “acquirer.” In one embodiment, cardholder 22 tenders payment for a purchase using a transaction card at a transaction processing device (e.g., transaction device) 40 (e.g., a point of sale device in an in-store context, or a mobile computing device (e.g., mobile phone) or desktop/laptop computer in an at-home (e.g., online shopping) context), then merchant 24 requests authorization from a merchant bank 26 for the amount of the purchase. The request is usually performed through the use of a point-of-sale terminal, which reads account information of cardholder 22 from a magnetic stripe, a chip, barcode, or embossed characters on the transaction card (e.g., a debit card or a prepaid card) and communicates electronically with the transaction processing computers of merchant bank 26. Alternatively, merchant bank 26 may authorize a third party to perform transaction processing on its behalf. In this case, the point-of-sale terminal will be configured to communicate with the third party. Such a third party is usually called a “merchant processor,” an “acquiring processor,” or a “third party processor.”

In the example embodiment, merchant 24 communicates with, either directly or indirectly via payment processing network 28, and DCF computing system 102 may be utilized to authenticate cardholder 22 before the transaction is further processed or to assist an authentication device that is part of the multi-party payment account system shown in FIG. 1 in authenticating cardholder 22. For example, DCF computing system 102 may authenticate cardholder 22 as described herein. Once cardholder 22 has been authenticated, using payment processing network 28, computers of merchant bank 26 or merchant processor will communicate with computers of an issuer bank 30 to determine whether a user account 32 of cardholder 22 is in good standing and whether the purchase is covered by an available credit line of cardholder 22. Based on these determinations, the request for authorization will be declined or accepted. If the request is accepted, an authorization code (e.g., included in an authorization message) is issued to merchant 24. An authorization message includes a transaction identifier associated with the transaction and an indicator indicating that the transaction was authorized. If the request is not accepted, authorization message includes a transaction identifier associated with the transaction and an indicator indicating that the transaction was declined. In the example embodiment, authorization message is formatted according to ISO 8583 network messaging protocol or the equivalent messaging protocol used by the payment card processing network.

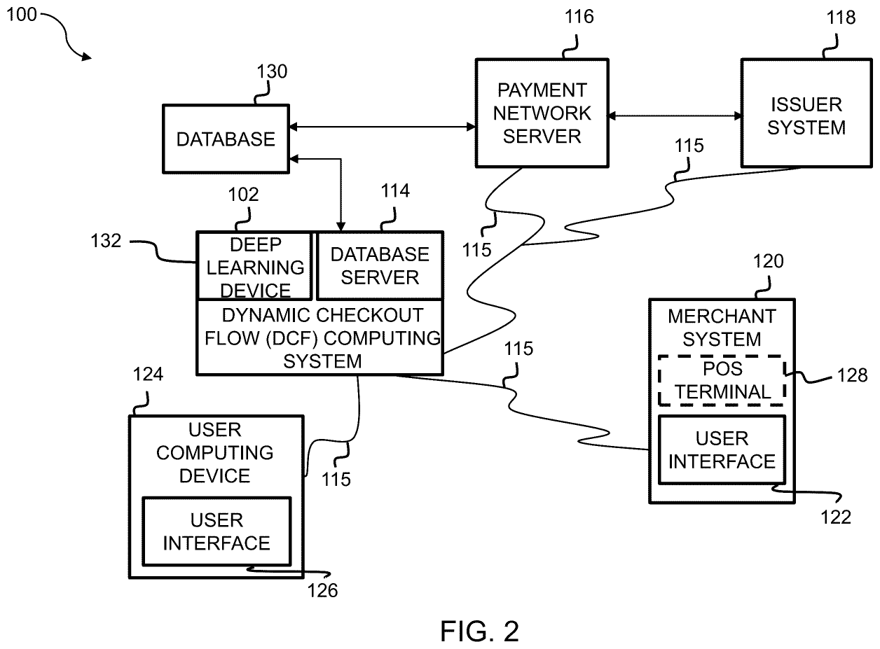

When a request for authorization is accepted, the available credit line of account 32 of cardholder 22 is decreased. Normally, a charge for a payment card transaction is not posted immediately to account 32 of cardholder 22 because certain rules do not allow merchant 24 to charge, or “capture,” a transaction until goods are shipped or services are delivered. However, with respect to at least some debit card transactions, a charge may be posted at the time of the transaction. When merchant 24 ships or delivers the goods or services, merchant 24 captures the transaction by, for example, appropriate data entry procedures on the point-of-sale terminal. This may include bundling of approved transactions daily for standard retail purchases. If cardholder 22 cancels a transaction before it is captured, a “void” is generated. If cardholder 22 returns goods after the transaction has been captured, a “credit” is generated. Payment processing network 28 and/or issuer bank 30 stores the transaction card information, such as a type of merchant, amount of purchase, date of purchase, etc. in a database (e.g., database 130, shown in FIG. 2).

After a purchase has been made, a clearing process occurs to transfer additional transaction data related to the purchase among the parties to the transaction, such as merchant bank 26, payment processing network 28, and issuer bank 30. More specifically, during and/or after the clearing process, additional data included in a clearing message, such as a time of purchase, a merchant name, a type of merchant, purchase information, user account information, a type of transaction, a transaction identifier, information regarding the purchased item(s) (e.g., product identifiers), information regarding container(s) of the purchased item(s) (e.g., container identifiers), and/or other suitable information, is associated with a transaction and transmitted between parties to the transaction as transaction data, and may be stored by any of the parties to the transaction. In the example embodiment, the clearing message is formatted according to ISO 8583 network messaging protocol or the equivalent messaging protocol used by the payment card processing network.

After a transaction is authorized and cleared, the transaction is settled among merchant 24, merchant bank 26, and issuer bank 30. Settlement refers to the transfer of financial data or funds among account of merchant 24, merchant bank 26, and issuer bank 30 related to the transaction. Usually, transactions are captured and accumulated into a “batch,” which is settled as a group. More specifically, a transaction is typically settled between issuer bank 30 and payment processing network 28, and then between payment processing network 28 and merchant bank 26, and then between merchant bank 26 and merchant 24.

As described above, the various parties to the payment card transaction include one or more of the parties shown in FIG. 1 such as, for example, user 22 (e.g., cardholder 22), merchant 24, merchant bank 26, payment processing network 28 (also referred to herein as payment processor 28), issuer bank 30, and/or an issuer processor 21. A transaction may be referred to in a temporal manner, such a historical (e.g., past or prior) transaction, and/or a current transaction (e.g., a transaction that may be occurring at any given current moment).

FIG. 2 is an expanded block diagram of an example embodiment of a dynamic checkout flow platform 100 used in providing the DCF service via dynamic checkout flow (DCF) computing system 102 in accordance with one example embodiment of the present disclosure. In the example embodiment, DCF platform 100 is used for providing the DCF service via dynamic checkout flow (DCF) computing system 102 as described herein.

More specifically, in the example embodiment, DCF platform 100 includes DCF computing system 102, and a plurality of client sub-systems connected to DCF computing system 102. Client sub-systems include issuer system 118 (also referred to as issuer computing device 118), merchant system 120 (also referred to as merchant computing device 120), and a user system 124 (also referred to as user computing device 124). In one embodiment, client sub-systems 118, 120, 124 are computers including a web browser, such that DCF computing system 102 is accessible to client sub-systems 118, 120, 124 using the Internet and/or using network 115. In other embodiments, client sub-systems 118, 120, 124 are computing programs (e.g., applications) provided within devices, such devices including but not limited to mobile devices (e.g., mobile phones, tablets), video game systems and video game software, headsets such as VR headsets and associated software, and other communication tools such as interactive chatbots and digital voice assistants. In the case of a VR headset, a user may be able to use an associated controller/joystick to enter a certain combination of joystick movements to serve as a password or pin. For example, the user may program into the VR system a combination of “left, left, right” on a joystick associated with the VR headset, where such “left, left, right” sequence is recognized by the VR system as authorizing a purchase from within a purchase portal or interface of the VR headset. In the case of chatbots and digital voice assistants, an audio profile (e.g., voice profile) may be used to authenticate and/or complete a purchase. For example, a user may designate a “safe word” that indicates their intent to purchase an item, and the chatbot or digital voice assistant would recognize the intent of such word when such word is entered or spoken by the user. The DCF computer system 102 can learn all of these input/interaction methods.

Client sub-systems 118, 120, 124 are connected to the Internet through many interfaces including a network 115, such as a local area network (LAN) or a wide area network (WAN), dial-in-connections, cable modems, special high-speed Integrated Services Digital Network (ISDN) lines, and RDT networks. Issuer system 118 includes systems associated with issuer banks 30 (shown in FIG. 1) as well as external systems used to store data. Merchant system 120 includes systems associated with merchants 24 (shown in FIG. 1) as well as external systems used to store data. For example, merchant system 120 may include a point-of-sale (POS) computing device 128 (also referred to as POS terminal 128) communicatively and operatively coupled to an external system of merchants 24. User computing device 124 includes systems associated with cardholders 22 (shown in FIG. 1) as well as external systems used to store data. DCF computing system 102 is also in communication with a payment network server 116 (also referred to as a payment processing network 116) associated with payment processing network 28 (shown in FIG. 1) using network 115. Further, client sub-systems 118, 120, 124 may additionally communicate with payment processing network 28 using network 115. In more general terms, client sub-systems 118, 120, 124 could be any device capable of interconnecting to the Internet including a web-based (e.g., mobile) phone, PDA, smart devices, or any other web-based connectable equipment. For example, user computing device 124 and POS terminal 128 are, without limitation, embodiments of transaction device 40 (see FIG. 1).

A database server 114 is connected to database 130, which contains information and data on a variety of matters. For example, database 130 may store user preference and transaction data and merchant rules regarding parameters of generating dynamic checkout flows, and server 114 may provide access to such data and rules stored in database 130. User preference data may be analyzed, sorted, and/or otherwise processed according to a list of defined parameters (e.g., transaction type, transaction time, device on which the transaction was initiated, dollar amount of transaction, market segment of merchant and/or item purchased, payment network parameters, and any other applicable parameter relating to ways to categorize such transactions). User preferences may include purchase factors, e.g., deliberations made by the purchaser while purchasing, such factors reflecting tendencies (e.g., likes, dislikes) of the purchaser. Put more simply, the user preferences reflect, for example, manual selections made by the user during various shopping sessions. Such manual selections including, for example, user interactions (e.g., clicking, touching) with a certain field, button, etc. of an interface (e.g., a checkout interface), with such interactions being reflective of user preferences. In one embodiment, centralized database 130 is stored on DCF computing system 102 and can be accessed by potential users at one of client sub-systems 118, 120, 124 by logging onto DCF computing system 102 through one of client sub-systems 118, 120, 124. Access to centralized database 130 is controlled by DCF computing system 102 to limit the display of data to authorized users enrolled with DCF computing system 102. In an alternative embodiment, database 130 is stored remotely from DCF computing system 102 and may be non-centralized. Database 130 may be a database configured to store information used by DCF computing system 102 including, for example, current transaction data, prompt data, other user data, historical transaction data, merchant data, merchant user interface components to be used as part of the DCF service, and/or other applicable data.

Database 130 may include a single database having separated sections or partitions, or may include multiple databases, each being separate from each other. In some embodiments, database 130 stores transaction data generated over the processing network including data relating to merchants, consumers, account holders, prospective customers, issuers, acquirers, and/or purchases made. Database 130 may include multiple storage units such as hard disks or solid state disks in a redundant array of inexpensive disks (RAID) configuration, and may include a storage area network (SAN) and/or a network attached storage (NAS) system.

In the example embodiment, merchant system 120 includes a user interface 122, and user computing device 124 includes a user interface 126. User interface 122 may include user interface components set by the merchant for operating merchant system 120, and may also include graphics to present the merchant with information about a user as determined and provided by DCF computing system 102, such as a report, metrics, or other output from the DCF service. User interface 126 may include a graphical user interface with interactive functionality for the purchase of goods/services from the merchant. For example, users of user interface 126 can interactively enter information into and make selections when making a purchase using user interface components (e.g., buttons, fields) of user interface 126, and answer or respond to prompts from DCF computing system 102, and input from the users of user interface 126 is transmitted to DCF computing system 102. DCF computing system 102 may be supported by payment processing network 28 and/or may process transaction and various other data. For example, user interface components of user interface 126 that are to be presented to a user of user computing device 124 during a checkout process may be stored on merchant system 120 and/or DCF computing system 102 so that such user interface components may be utilized as part of the DCF service. In one embodiment, a merchant may use merchant user interface 124 to define checkout flow processes and parameters on the end of the merchant (e.g., at merchant system 120). These checkout flow processes and parameters may include checkout flow graphics and other information (e.g., rules regarding how to present certain checkout information to a user such as user 22) to be presented on user interface 126 to a user (e.g., user 22). If the merchant participates in the DCF service provided by the DCF provider by way of DCF computing system 102, the merchant may also provide their checkout flow processes and parameters to DCF computing system 102 so that DCF computing system 102 can use the checkout flow processes and parameters to tailor the checkout process flow for individual users based on user preference/behavior models created by DCF computing system 102 for each individual user. In doing so, the merchant can ensure that DCF computing system 102 has the most current user interface components and operates according to the desired set of rules promulgated by the merchant to DCF computing system 102. Additionally, DCF computing system 102 includes a deep learning device 132, discussed in more detail below (while deep learning device is shown as part of DCF computing system 102, it can instead be associated with other components of DCF platform 100, including but not limited to database 130).

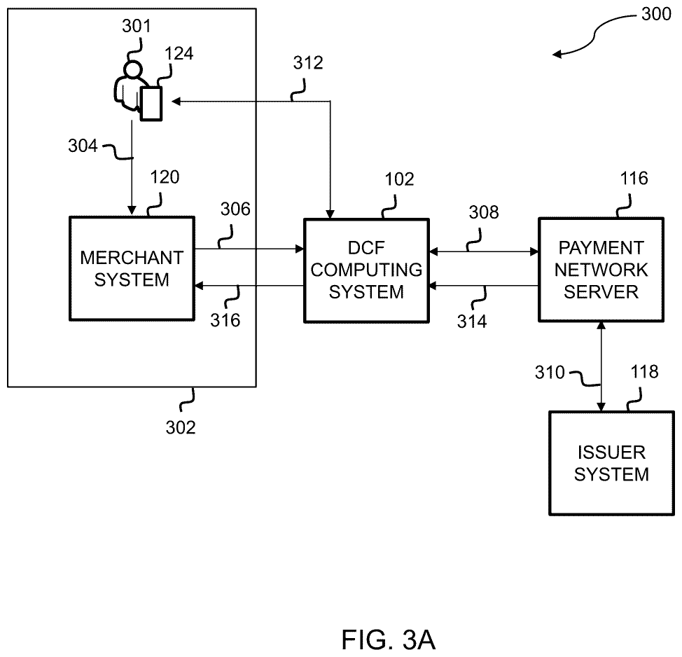

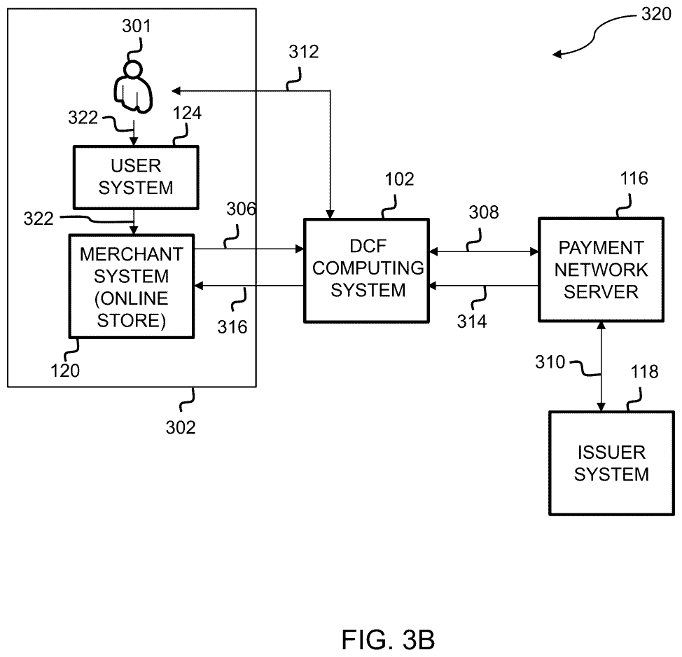

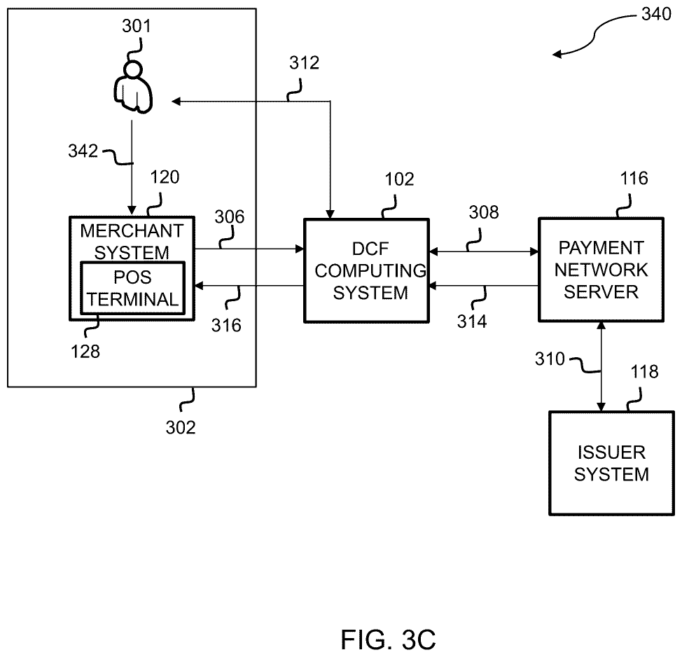

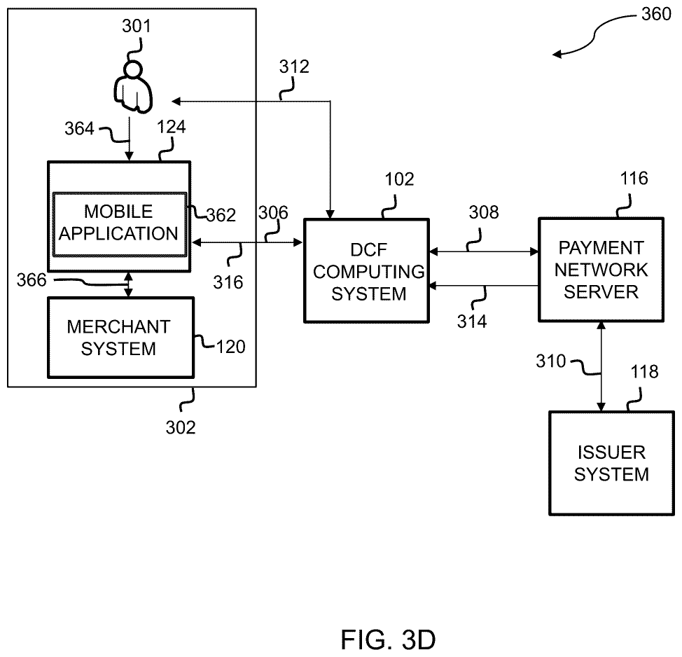

FIG. 3A is a data flow diagram 300 showing an example flow of data within DCF platform 100 (shown in FIG. 2), and FIGS. 3B-3D are data flow diagrams 320, 340, and 360 showing example flows of data for specific transaction types within diagram 300 in accordance with example embodiments of the present disclosure. That is, FIG. 3A illustrates a high-level flow of data, and FIGS. 3B-3D show additional data flows for more specific transaction types (e.g., online store transactions, POS transactions, mobile app transactions).

In FIG. 3A, diagram 300 illustrates a high-level flow of data for all transactions processed in association with DCF platform 100 (shown in FIG. 2). A user 301 associated with user computing device 124 initiates 302 a transaction with merchant system 120. To initiate 302 the transaction, user 301 transmits user information 304 to merchant system 120. User information 304 may include payment information (e.g., type of payment) and name and address information, but may also include other information relating to how user 301 has interacted with user interface components (e.g., UI usage information) presented to user 301 during a checkout process of the transaction. UI usage information may include storing of various selections (e.g., manual selections) made by user 301 during the checkout process. These selections may include the response of user 301 to being offered various other goods/services in addition to the primary item (e.g., good/service) being purchased, for example insurance/warranty coverage for the to-be-purchased good/service, and/or additional items and/or promotions related to the primary good/service being purchased. For example, during checkout, merchant system 120 may present (e.g., via user interface 126) to user 301 an option to buy a second item at a reduced price (e.g., buy one get one (BOGO) at 50% off). The response of user 301 to such additional offer(s) is stored and transmitted to DCF computing system 102, so that DCF computing system 102 may use the new user behavior to help further build and/or refine a user preference/behavior model of user 301 created by DCF computing system 102.

As further shown in FIG. 3A, merchant system 120 is in communication with DCF computing system 102 and transmits data regarding the transaction via transaction data transfer message 306 to DCF computing system 102 to initiate the transfer of new user behavior data of user 301 DCF computing system 102. In the example embodiment, transaction data transfer message 306 includes transaction data (i.e., any data associated with the transaction including a payment account identifier and/or a user identifier, a merchant identifier, a transaction amount, a transaction location, user selections made during a checkout process, etc.). Transaction data transfer message 316 is similar to transaction data transfer message 306 but is sent from DCF computing system 102 to merchant system 120. Interfaces (e.g., user interfaces, components of user interfaces), or other data acted on or otherwise modified by DCF computing platform 100 and/or DCF computing system 102 may be referred to herein as being “DCF-modified” and/or “model-defined.”

DCF computing system 102 may also provide authentication and/or fraud functions. As the DCF service learns more and more about individual user behavior, it will learn, for example, the manner in which any particular user tends to add items to their online shopping cart. The DCF service may learn that a certain user tends to add just a few items (e.g., 3 items) in a gradual manner throughout the course of their online shopping session. If, in another online shopping session, the DCF service recognizes that a large amount of items were suddenly added to the online shopping cart in rapid fashion, the DCF service may flag this behavior as being inconsistent with known behavior for that user, and may trigger a fraud detection message to be sent, such fraud detection message indicating suspicious behavior and being a call for action. Such call for action may include, for example, a user authentication prompt presented during the checkout to ensure that the user was the entity that added items to the shopping cart in the manner inconsistent with their learned behavior as stored in their DCF user model. If the user is able to satisfactorily respond to the user authentication prompt (e.g., providing their identity), then the transaction will be permitted to proceed. If not, the DCF service may take steps to end the transaction, such as informing the merchant and/or logging the user out of the merchant website. User authentication prompts may include one-time codes, providing answers to stored identification questions (e.g., “What city did you attend college?”), and may be tailored to learned user preferences for authentication. For example, a particular user may prefer to receive a one-time code over answering identification questions. The DCF service is therefore able to both accommodate rules/requirements set by the merchant or other participating partner of the DCF service, while also adhering to user preferences.

Further regarding fraud and authentication aspects, as shown in FIG. 3A, the DCF computing system 102 is in communication with payment network server 116 and issuer system 118. To authenticate a user, DCF computing system 102 requests user data 308 specific to user 301 from payment network server 116. User data 308 may include historical transaction data of user 301. From user data 308, DCF computing system 102 is able to create and update an individual user model for user 301, and determine transaction trends, common transactions, reoccurring transactions, unique transactions, typical transaction limits, etc. for user 301. DCF computing system 102 determines, from a database (e.g., database 130 shown in FIG. 2) associated with DCF computing system 102, a user 301 and corresponding user identifier by performing a look-up in the database for the user and the corresponding user identifier associated with the transaction data included in authorization request message 306. In some embodiments, the transaction data includes a payment account identifier that can identify the user and user identifier. In other embodiments, like for card-not-present transactions, the transaction data includes a username/password or token that can identify the user and user identifier. DCF computing system 102 transmits the user identifier to payment network server 116 in a request (e.g., a query) for user data associated with user 301. In other embodiments, DCF computing system 102 transmits the payment account identifier to payment network server 116, and payment network server 116 determines user 301 and corresponding user identifier associated with the payment account identifier.

Further, DCF computing system 102, either alone or together with payment network server 116, determines a risk associated with the transaction based upon the transaction data included in authorization request message and/or user data 308, as described in further detail below. Higher risks are associated with transactions that have a higher likelihood of being fraudulent and/or disputable and transactions carried out at merchants known to have a high rate of fraudulent transactions. Lower risks are associated with transactions that have a lower likelihood of being fraudulent and/or disputable and transactions carried out at merchants known to have low rates of disputable transactions. Due to the risk associated with higher risk transactions, a user 301 that initiates higher risk transactions requires more secure and challenging authentication than if user 301 initiates lower risk transactions. For higher risk transactions, more specific and in-depth data may be needed for DCF computing system 102 to thoroughly authenticate users 301 associated with the higher risk transactions. Accordingly, DCF computing system 102 and/or payment network server 116 requests and receives in-depth user data 310 from issuer system 118 (e.g., of the issuer that issues the payment account associated with the transaction). In-depth user data 310 includes, address, phone number, email, social security number, credit history, and other user-specific account information in which issuer system 118 has access.

Using user data 308 and/or in-depth user data 310 and AI/ML techniques described herein, DCF computing system 102 may generate and transmit prompts 312, as part of a DCF-modified UI, to user computing device 124 of user 301 or a user interface of merchant system 120 based upon the risk associated with the transaction. Harder prompts 312 are transmitted for higher-risk transactions, and easier prompts 312 are transmitted for lower-risk transactions. Prompts 312 are structured in a variety of different ways including short answer questions where user 301 inputs answers to prompts using a keypad or number pad of user device 124 and/or a user interface of merchant system 120 or multiple choice prompts 312 where user 301 picks a correct choice from two or more options. For example, easier prompts 312 may include questions including “How much did you spend at Merchant A last night?” “Who is your cell phone provider?” etc. Harder prompts 312 may include questions including “You made an abnormally large purchase last week-what store was it made at?” “What are the last four digits of your social security number?” “What is your mother's maiden name?” etc. Further, for example, easier prompts 312 may include a prompt with two or three multiple choice answers when harder prompts 312 may include a short answer prompt.

Based upon responses of user 301 to prompts 312, DCF computing system 102 determines whether user 301 is authenticated, whether user 301 requires additional, harder prompts 312 to be authenticated, or whether user 301 is not authenticated. Further, DCF computing system 102 assigns a risk score to each response based upon how accurate the response of user 301 is. Responses with high accuracy (e.g., response is the correct answer of a multiple choice prompt or response is a highly accurate short answer response) are assigned a low risk score while responses with low accuracy (e.g., response is the incorrect answer of a multiple choice prompt or response is an inaccurate short answer response) are assigned a high risk score. For example, if prompt 312 is “How much did you spend on lunch yesterday?” user 301 answers “$7,” and the correct answer, as determined by DCF computing system 102, is $6.83, DCF computing system 102 would assign a low risk score to the answer because the answer is mostly accurate. However, if prompt 312 is “How much did you spend on lunch yesterday?” user 301 answers “$15,” and the correct answer is $6.83, DCF computing system 102 would assign a high risk score to the answer because the answer is inaccurate. Thresholds for accuracy of prompts 312 may be determined by merchants, DCF computing system 102, payment processor 28, and/or issuers.

If DCF computing system 102 assigns one or more responses of user 301 with a high risk score, DCF computing system 102 generates and transmits additional, more difficult prompts 312 for user 301 to answer. If user 301 answers the additional prompts correctly and a low risk score is assigned to the answers of additional, more difficult prompts 312, DCF computing system 102 authenticates user 301. If user 301 answers the additional prompts incorrectly and again has a high risk score assigned to the answers of the additional, more difficult prompts 312, DCF computing system 102, declines authentication of user 301, and/or embeds the high risk score in a signal to issuer system 118. Further, when DCF computing system 102 declines authentication of user 301, or issuer system 118 responds to the high risk score embedded by DCF computing system 102, the transaction initiated by user 301 is declined, either by issuer system 118 or by DCF computing system 102 configured to act on behalf of issuer system 118 in response to a declined authentication. While prompts 312 have been discussed above relative to authentication and fraud aspects, prompts 312 may encompass any number of prompts to the user. For example, a button such as a fast checkout (e.g., “checkout now”) button may be a prompt within prompts 312 (e.g., prompting the user to checkout by using the fast checkout button).

When user 301 is authenticated, DCF computing system 102 receives additional payment information 314 from payment network server 116. For example, additional payment information may include a payment account identifier including payment token numbers, expiry date, CVC, address, etc. Additional payment information 314 is securely transmitted to DCF computing system 102 without further user 301 involvement. DCF computing system 102 embeds an authentication indicator (e.g., indicating that user 301 is authenticated) and any necessary additional payment information 314 to merchant system 120 to complete authorization of the transaction for the merchant. Further, DCF computing system 102 transmits all authentication data to payment processor server 116 for further processing (e.g., clearing and transferring of funds).

Moreover, DCF computing system 102 is always learning from the responses of user 301 to the prompts 312. For example, DCF computing system 102 may learn that user 301 prefers to authenticate by entering in the last four digits of their social security number, and DCF computing system 102 will adjust to always present “What are the last four digits of your social security number?” as the first prompt 312 to user 301, based on the learned behavior of user 301. This benefits all parties by ensuring that the transaction is valid and providing the merchant and/or issuer with confidence, while also not burdening the user with a litany of questions that may frustrate the user and cause the user to not make purchases from the particular merchant going forward. While prompts 312 are discussed in connection with FIG. 3A in connection with fraud and authentication aspects, prompts 312 may have a more general function as described below in more detail.

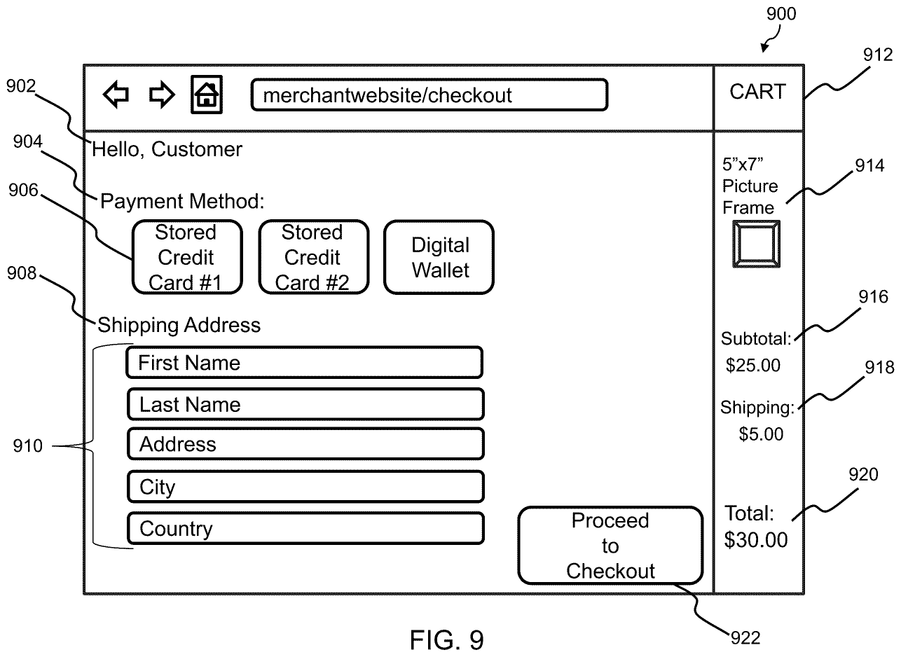

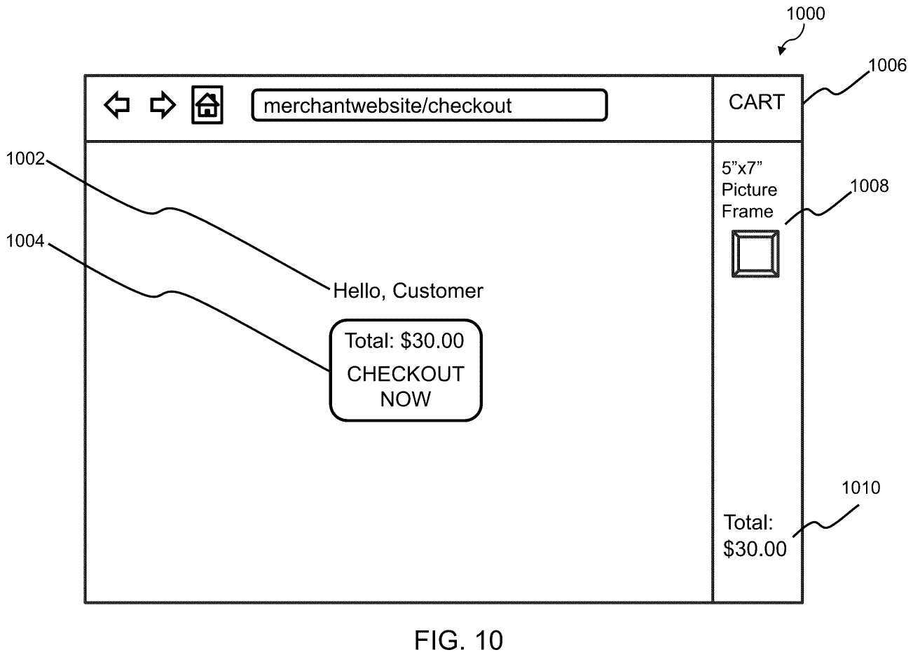

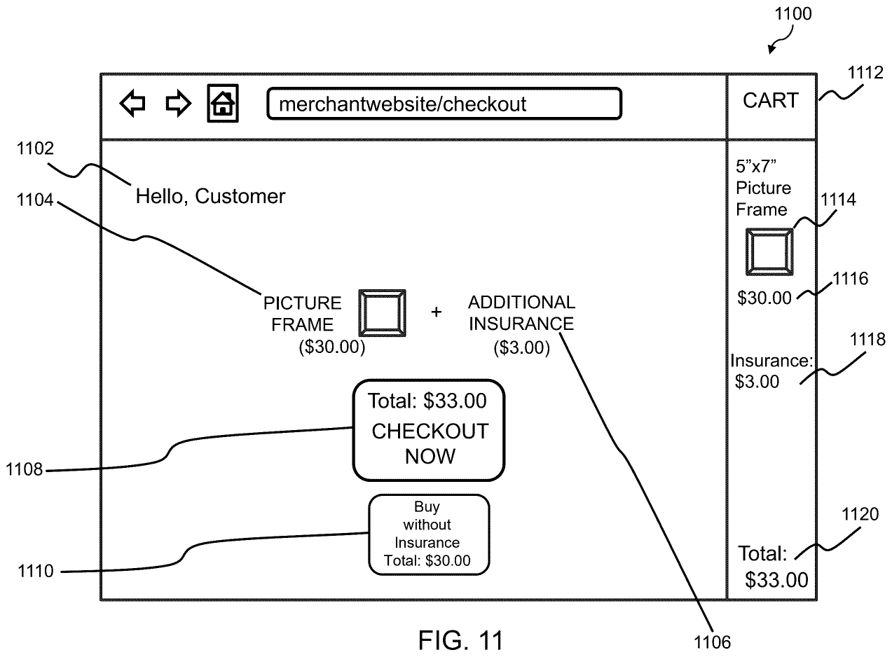

FIG. 3B illustrates data flow diagram 320 showing an example flow of data within DCF platform 100 (shown in FIG. 2) for an electronic transaction. Data flow diagram 320 is substantially similar to data flow diagram 300 except that data flow diagram 320 shows additional detail of how user 301 initiates 302 the electronic transaction. That is, data flow diagram 320 shows an example data flow when a display screen of user system 124 has been modified by the DCF service provided by DCF computing system 102 to accommodate the learned preferences of user 301. More specifically, user 301 browses an online store of an online merchant through a web browser of user system 124. At checkout, the checkout process of merchant 120 is presented via the web browser in a manner dictated by merchant rules as well as the user model of the DCF service for user 301 (examples of how the checkout process flow presentation can be augmented and implemented by the DCF service to be tailored to the preferences of a user when online shopping via a web browser are shown in FIGS. 9-11, for example). Once user 301 is ready to check out (e.g., to initiate 302 the electronic transaction), user 301 utilizes the DCF-modified user interface (e.g., 126) of the web browser as provided by the DCF service to finalize the purchase. This may include user 301 entering preferred payment method 322 into user system 124, and user system 124 transmits payment method 322 to the online merchant system 120, in the manner determined by the DCF service to match the preferences of user 301 and to adhere to the rules/goals/objectives of the merchant. Online merchant store 120 then interacts with DCF computing system 102 to provide DCF computing system 102 with the new transaction data and further update the DCF model for this particular user, and to potentially also authenticate user 301 and authorize the electronic transaction as discussed, for example, in connection with FIG. 3A. Additionally, prompts 312 may be provided in the form of DCF-modified purchase prompts (e.g., 1004, 1108, 1110 in FIGS. 10 and 11).

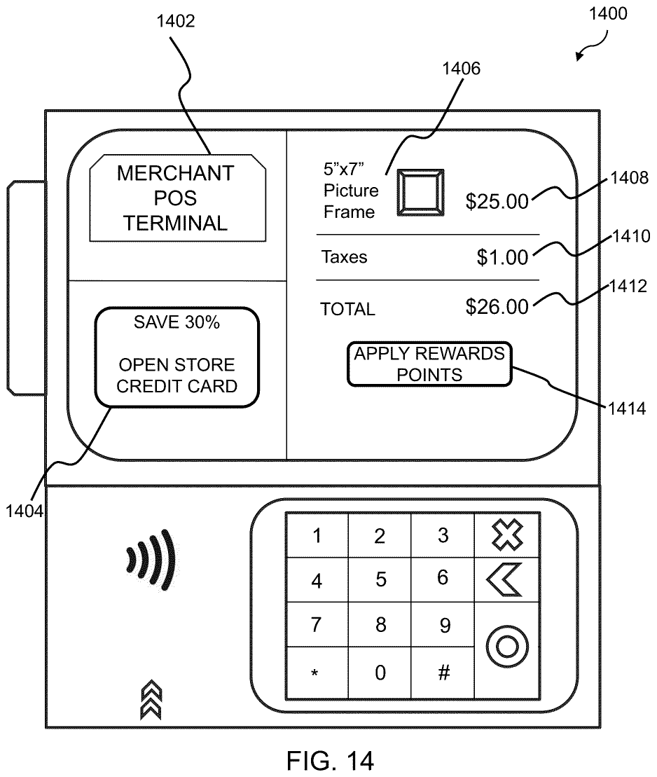

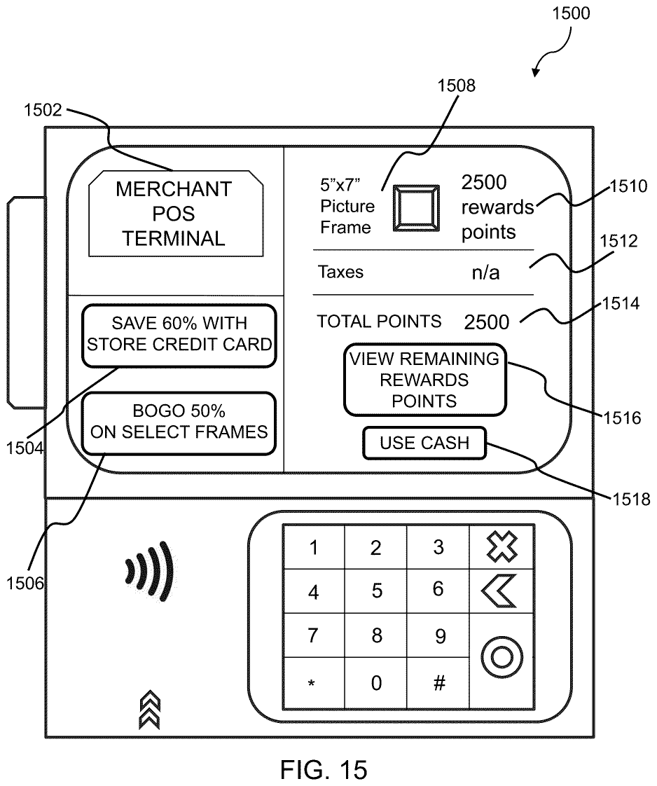

FIG. 3C illustrates data flow diagram 340 showing an example flow of data within DCF platform 100 (shown in FIG. 2) for an in-store transaction where user 301 completes the checkout process through a POS terminal 128 of merchant system 120. That is, data flow diagram 340 shows an example data flow where a display screen of POS terminal 128 has been modified by the DCF service provided by DCF computing system 102 to accommodate the learned preferences of user 301. Data flow diagram 340 is substantially similar to data flow diagram 300 except that data flow diagram 340 shows additional detail of how user 301 initiates 302 the in-store transaction. Using POS terminal 128, user 301 is presented with a user interface (e.g., 122) that has been modified to match the preferences of user 301 as learned by DCF computing system 102 and as implemented through the display screen of POS terminal 128. For example, in order to tailor the display screen of POS terminal 128 to user 301, the merchant may first require user 301 to enter identifying information into merchant system 120, such as by way of swiping a merchant loyalty/rewards card, entering a loyalty/rewards program account number, or entering mobile number and/or address information, in order to trigger the DCF-modified interface to appear on the display screen of POS terminal 128. This technique may be needed when if user 301 will not be paying with a credit card linked to the DCF service provided by DCF computing system 102. Ordinarily the DCF-modified checkout screen on POS terminal 128 triggers once the user swipes their payment card (e.g., a payment card linked to the DCF service provided by DCF computing system 102). This may include user 301 entering either a payment account identifier 342 (e.g., a pin number) to POS terminal 128 to initiate 302 the in-store transaction (examples of how the checkout process flow presentation can be augmented and implemented by the DCF service to be tailored to the preferences of a user when using a POS terminal 128 are shown in FIGS. 14 and 15, for example). DCF computing system 102 determines the user 301 associated with payment account identifier 342, and authenticates the user as shown in data flow diagram 300. DCF computing system 102 may determine that in-store transactions are riskier and generate and transmit difficult prompts 312 to user 301 through POS terminal 128. Additionally, or alternatively, prompts 312 may be configured for purposes other than authentication, such as DCF-modified purchase prompts (e.g., 1404, 1414, 1504, 1506, 1516, 1518) in FIGS. 14 and 15). However, user 301 is still able to carry out the transaction because of DCF computing system 102 and the dynamic authentication processes of DCF computing system 102.

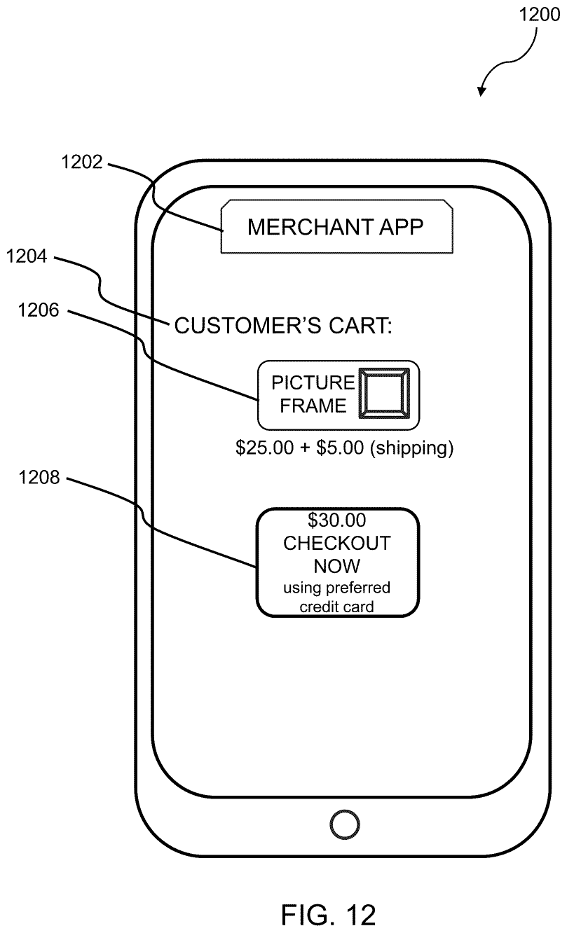

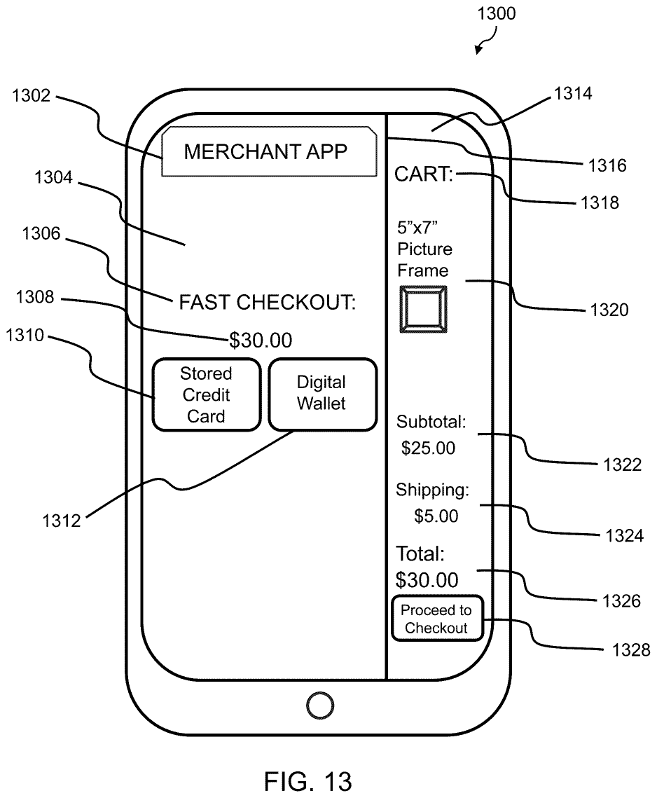

FIG. 3D illustrates data flow diagram 360 showing an example flow of data within DCF platform 100 (shown in FIG. 2) for when the DCF service provided by the DCF computing system 102 is presented via a mobile application on user computing device 124 (e.g., when user computing device 124 is a mobile phone that has the merchant's application installed thereon, in other words, not a web-browser as described in connection with FIG. 3B). That is, data flow diagram 320 shows an example data flow when a display screen of user system 124 has been modified by the DCF service provided by DCF computing system 102 to accommodate the learned preferences of user 301. Data flow diagram 360 is substantially similar to data flow diagram 300 except that data flow diagram 360 shows additional detail of how user 301 initiates 302 the transaction via a mobile device (e.g., 124) of user 301. Similar to data flow diagram 340, user 301 initiates 302 the transaction without a payment card and by inputting either a payment account identifier 364 (e.g., a credit card number or a username/password). In data flow diagram 360, user computing device 124 (e.g., including mobile application 362 thereon) is used to complete the transaction. That is, the checkout process flow presentation of application 362 has been modified by the DCF service provided by DCF computing system 102 according to the preferences of user 301 and the rules/goals/objectives of the merchant (see example DCF-modified user interfaces (e.g., 126) in FIGS. 12 and 13). User 301 may receive prompts 312 through application 362 to finalize the checkout process (see example DCF-modified prompts (e.g., 1206, 1208, 1310, 1312) in FIGS. 12 and 13). There may be two-way data transfer 366 between mobile application 362 and merchant system 120 (e.g., for providing of functionally of application 362, etc.).

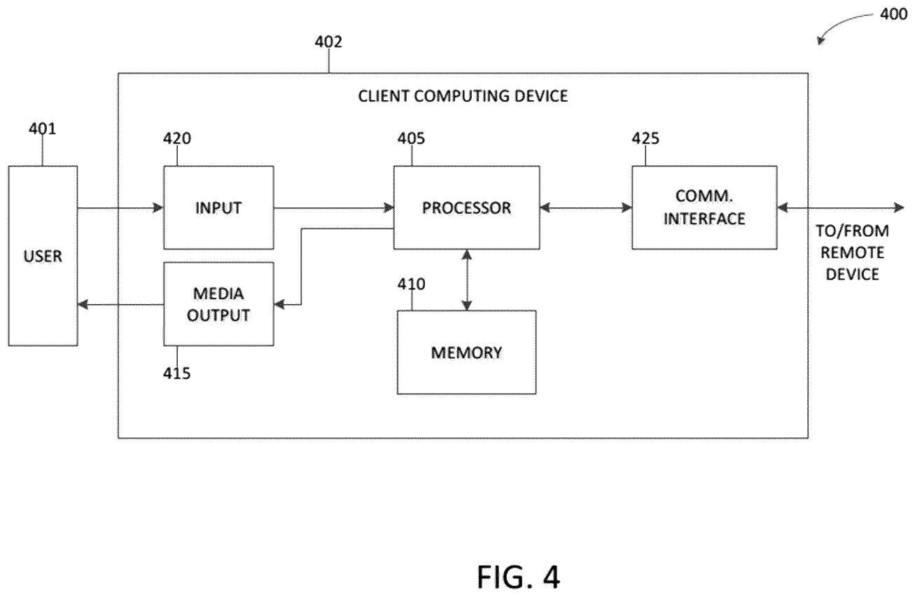

FIG. 4 illustrates an example configuration of a client computing device 402. Client computing device 402 may include, but is not limited to, merchant system 120 and/or user computing device 124 (shown in FIG. 2). Client computing device 402 includes a processor 405 for executing instructions. In some embodiments, executable instructions are stored in a memory area 410. Processor 405 may include one or more processing units (e.g., in a multi-core configuration). Memory area 410 is any device allowing information such as executable instructions and/or other data to be stored and retrieved. Memory area 410 may include one or more computer-readable media.

Client computing device 402 also includes at least one media output component 415 for presenting information to a user 401 (e.g., cardholder 22, shown in FIG. 1). Media output component 415 is any component capable of conveying information to user 401. In some embodiments, media output component 415 includes an output adapter such as a video adapter and/or an audio adapter. An output adapter is operatively coupled to processor 405 and operatively couplable to an output device such as a display device (e.g., a liquid crystal display (LCD), organic light emitting diode (OLED) display, cathode ray tube (CRT), or “electronic ink” display) or an audio output device (e.g., a speaker or headphones).

In some embodiments, client computing device 402 includes an input device 420 for receiving input from user 401. Input device 420 may include, for example, a keyboard, a pointing device, a mouse, a stylus, a touch sensitive panel (e.g., a touch pad or a touch screen), a camera, a gyroscope, an accelerometer, a position detector, and/or an audio input device. A single component such as a touch screen may function as both an output device of media output component 415 and input device 420.

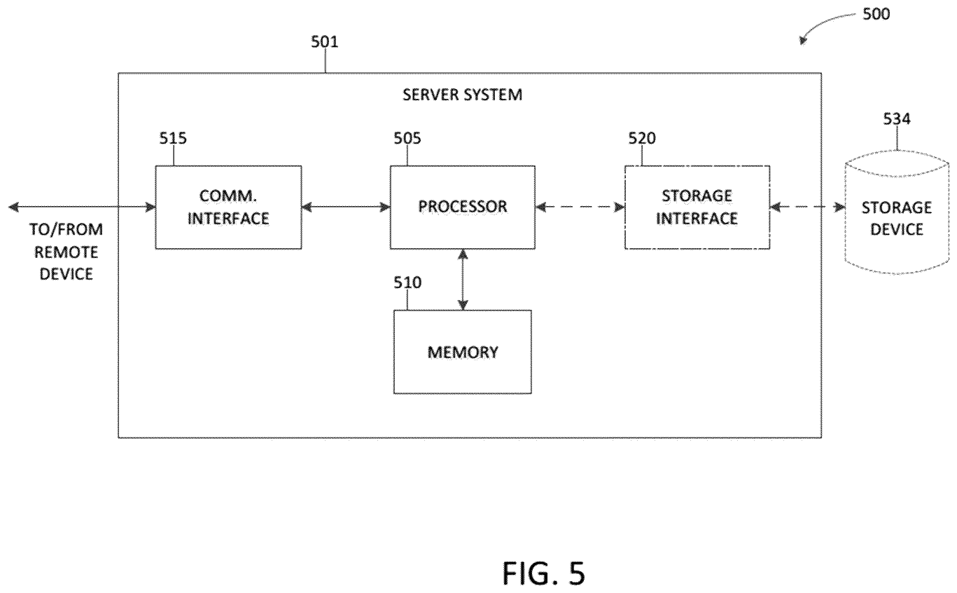

Client computing device 402 may also include a communication interface 425, which is communicatively countable to a remote device such as a server system (e.g., server system 501 shown in FIG. 5) or a web server. Communication interface 425 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

Stored in memory area 410 are, for example, computer-readable instructions for providing a user interface (e.g., 126) to user 401 via media output component 415 and, optionally, receiving and processing input from input device 420. A user interface (e.g., 126) may include, among other possibilities, a web browser and client application. Web browsers enable users 401 to display and interact with media and other information typically embedded on a web page or a website from a web server. A client application allows users 401 to interact with a server application associated with, for example, DCF computing system 102. The user interface, via one or both of a web browser and a client application, facilitates displaying prompts generated by DCF computing system 102. The user may interact with the user interface to view and respond to prompts using input device 420.

FIG. 5 illustrates an example configuration of a server (host computing device) system 501 such as DCF computing system 102, payment network server 116, and/or issuer system 118 (shown in FIG. 2) used to receive transaction data associated with payment transactions and authenticate users of the payment transactions using a DCF service.

Server system 501 includes a processor 505 for executing instructions. Instructions may be stored in a memory area 510, for example. Processor 505 may include one or more processing units (e.g., in a multi-core configuration) for executing instructions. The instructions may be executed within a variety of different operating systems on the server system 501, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

Processor 505 is operatively coupled to a communication interface 515 such that server system 501 is capable of communicating with a remote device such as another server system 501. For example, communication interface 515 may receive requests from payment network server 116 and/or issuer system 118 via the Internet, as illustrated in FIG. 2. Processor 505 may also be operatively coupled to a storage device 534. Storage device 534 is any computer-operated hardware suitable for storing and/or retrieving data. In some embodiments, storage device 534 is integrated in server system 501. For example, server system 501 may include one or more hard disk drives as storage device 534. In other embodiments, storage device 534 is external to server system 501 and may be accessed by a plurality of server systems 501. For example, storage device 534 may include multiple storage units such as hard disks or solid state disks in a redundant array of inexpensive disks (RAID) configuration. Storage device 534 may include a storage area network (SAN) and/or a network attached storage (NAS) system. In some embodiments, server system 501 also includes a database server, such as database server 114 (shown in FIG. 2).

In some embodiments, processor 505 is operatively coupled to storage device 534 via a storage interface 520. Storage interface 520 is any component capable of providing processor 505 with access to storage device 534. Storage interface 520 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 505 with access to storage device 534.

Memory area 510 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

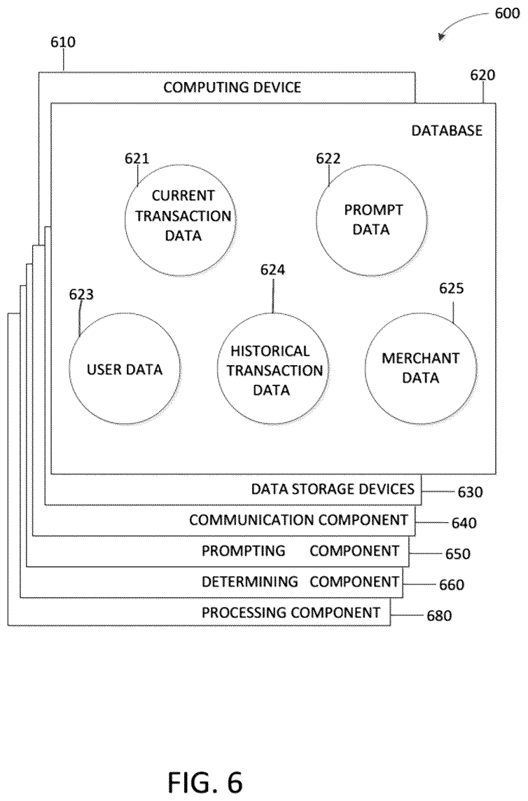

FIG. 6 is a diagram of components 600 of one or more example computing devices 610 (e.g., DCF computing system 102) that may be used in the platform 100 environment shown in FIG. 2. Computing device 610 includes database 620 as well as data storage devices 630, a communication component 640, a prompting component 650, a determining component 660, and a processing component 680. Database 620 may store information such as, for example, current transaction data 621, prompt data 622, user data 623, historical transactions data 624 and merchant data 625. For example, current transaction data 621 includes data related to transactions currently being processed by payment processing network 28 and/or payment network server 116, prompt data 622 includes language elements, rules, and/or model parameters used to generate the prompts (e.g., 312) as discussed above, user data 623 includes user data 308 and/or in-depth user data 310, historical transaction data 624 includes data related to transactions previously processed by one or more payment processing networks such as payment processing network 28, and merchant data 625 includes data relating to various merchants registered to submit transactions for authorization via payment processing network 28. Database 620 is coupled to several separate components within DCF computing system 102, which perform specific tasks. In some embodiments, database 620 is substantially similar to database 130 (shown in FIG. 2).

Communication component 640 facilitates communication between computing device 610 and other systems (e.g., payment network server 116 and/or issuer system 118, as shown in FIG. 2). Prompting component 650 is used to generate one or more prompts (e.g., 312) as part of the DCF service provided by the DCF computing system 102. For example, prompting component 650 may be heavily utilized in the case where an interactive chatbot is part of the DCF service, or for the presentation of customized buttons matching the user's determined button preferences (as discussed herein in connection with prompts 312 and the buttons shown in FIGS. 9-15). Determining component 660 is used to determine various aspects, such as a risk associated with transactions such as discussed above in connection with fraud/authentication aspects, or more generally user preferences as learned by the DCF computing system 102. Processing component 680 processes data and performs other steps as described herein.

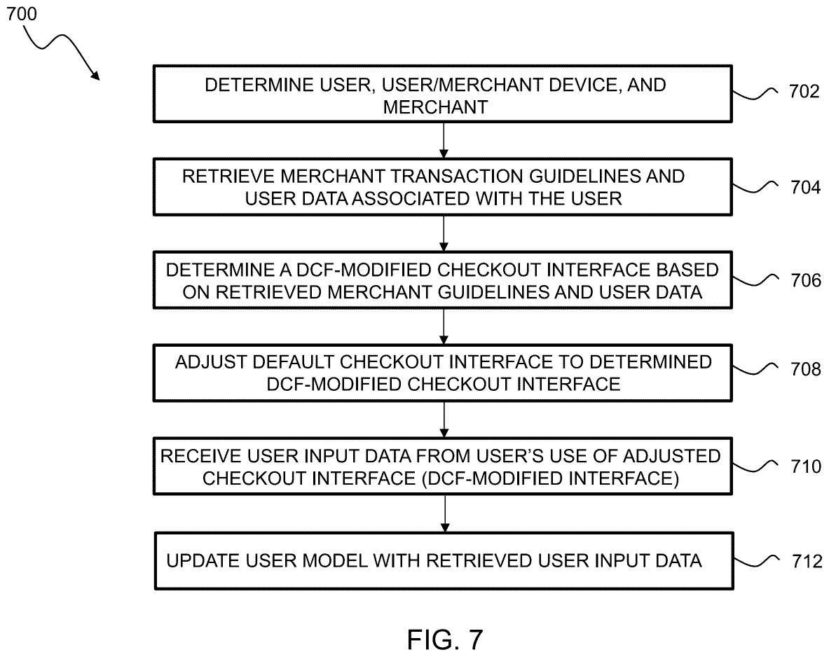

FIG. 7 illustrates a flow chart of an example method 700 for implementing a dynamic checkout flow (DCF) service provided by DCF computing system 102. Method 700 may be performed by DCF computing system 102 and related devices and systems (shown in FIG. 2) as applicable.

In the example embodiment, method 700 includes determining 702 each of a user, the merchant the user is shopping at, and the type of device (e.g., mobile device, POS terminal) being used to conduct the transaction. The type of user/merchant device may be determined based on identifying features of the merchant system (e.g., 120) and user device (e.g., 124), such as IP address or other device-specific information (e.g., IMEI number, Terminal Identification Number (TID)) capable of being used to determine/identify a specific device on a network. The user may be identified/determined by, for example, which credit card they use for the transaction, or other information entered as part of the transaction process, such as a phone number, address, or other information such as a merchant loyalty/rewards account of the user managed by the merchant.

Method 700 further includes retrieving 704, from a memory, merchant transaction guidelines and user data associated with the user. Merchant transaction guidelines (e.g., merchant instructions) may include any plurality of rules and/or other parameters set by the merchant and uploaded or otherwise made available to DCF computing system 102, including sales goals and other business objectives of the merchant, and any other aspects relating to any plurality of transaction processes. These goals and objectives may include both short-term and long-term goals and objectives. For example, a long-term goal of the merchant may be increased user sign-ups for the merchant's store credit card. A short-term goal of the merchant may be to increase seasonal sales of a particular item. Other merchant guidelines may include merchant rules for how to display certain UI components on the merchant's website, mobile application, and/or POS terminal. This may include particular logo placement rules on display screen interfaces, text field placement rules, button placement rules, etc. Moreover, the merchant transaction guidelines may include designations as to which UI components may be modified by the DCF service, and which UI components may not be modified by the DCF service. For example, a certain merchant may only permit the DCF service to make limited dynamic adjustments to the UI interface, whereas other merchants may be more permissive and allow the DCF service to make wide-scale adjustments. This is based on merchant preference, and can be defined in the merchant guidelines, so that the DCF computing system 102 can implement the merchant guidelines as part of its dynamic adjusting of the checkout process flow for the merchant.

Based upon the merchant guidelines (e.g., merchant instructions) and the user data, a DCF-modified checkout interface is determined 706 by the DCF computing device 102. The DCF-modified checkout interface may be determined based on a plurality of factors stemming from the merchant guidelines and the user data. Visual examples of DCF-modified UI's are presented in FIGS. 10-15. As disclosed herein, the DCF computing system 102 learns over time the behaviors and preferences of a user. For example, if a user has responded favorably to certain user interface components in the past, the DCF computing system 102 will assign weights to such features and arrange a checkout process flow that is tailored to the user's preferences and behaviors. DCF computing system 102 can draw associations between parameters of user preferences and parameters of merchant instructions, and such parameters and parameter associations, alone or in combination, can be used as part of the user-specific model (described below in more detail) to realize the beneficial effects of the DCF service. The DCF-modified checkout interface can include modifications to both front-facing and back-end aspects of the user's checkout preferences. For example, the visual layout of the DCF-modified checkout interface may cater to the user's visual preferences, whereas the underlying functionality of various buttons and other interactive elements of the UI may cater to the user's preferred checkout experience, such as preferred payment option(s) (e.g., using a certain digital wallet as default payment), or other functional backend aspects defined by the merchant guidelines. Moreover, DCF computing system 102 may group merchants by market segment to provide more nuanced insight into a purchaser's behavior within a particular market segment, and to provide additional insight into certain market segments.

Method 700 further includes adjusting 708 an existing (e.g., default) checkout interface to the determined DCF-modified checkout interface. With reference to FIGS. 9-11, adjusting 708 may include making adjustments to a default UI such as shown in FIG. 9, to arrive at DCF-modified checkout interfaces such as shown in FIGS. 10 and 11 (discussed in more detail below). For example, a comparison of screen 900 in FIG. 9 with screen 1000 in FIG. 10 shows that the “Proceed to Checkout” button 922 of screen 900 has been replaced with a centrally located “CHECKOUT NOW” button 1004 based on the preferences of the user learned by DCF computing system 102 and implemented via DCF computing system 102 to adjust the default checkout interface to a checkout interface tailored to the particular user. DCF computing system 102 may make these adjustments on the fly, for example as soon as DCF computing system 102 detects the user is viewing the items in their online shopping cart. This is just one example of how DCF computing system 102 can be triggered to start the dynamic modification process. Another option is that the DCF-modified checkout interface is loaded for use as soon as a user logs into their merchant account (e.g., before the user even navigates to their cart).

Method 700 further includes receiving 710 user input data from the user's use (e.g., navigation and selection) of the adjusted checkout interface (e.g., DCF-modified checkout interface), and updating 712 a user model of the DCF computing system with the retrieved user input data stemming from the transaction. Because the DCF computing system 102 continuously ingests user data to update and improve user models (described in more detail below), each new transaction serves as an additional data point to update and improve a user model. This allows for DCF computing system 102 to provide the dynamic interface changes disclosed herein. Because user preferences can change over time, by ingesting data from each new user transaction, the DCF computing system 102 can always have current user preference/behavior models to use for dynamically adjusting interfaces based on recent user trends.

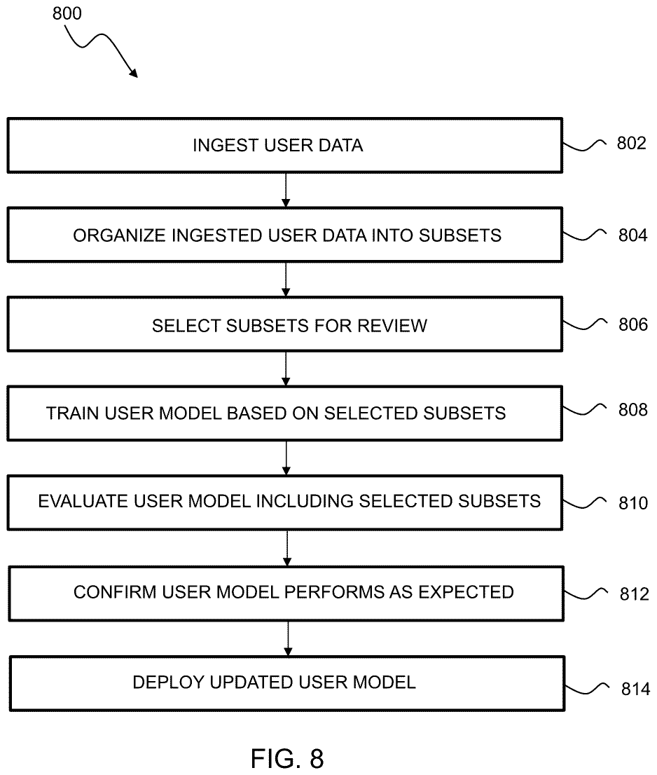

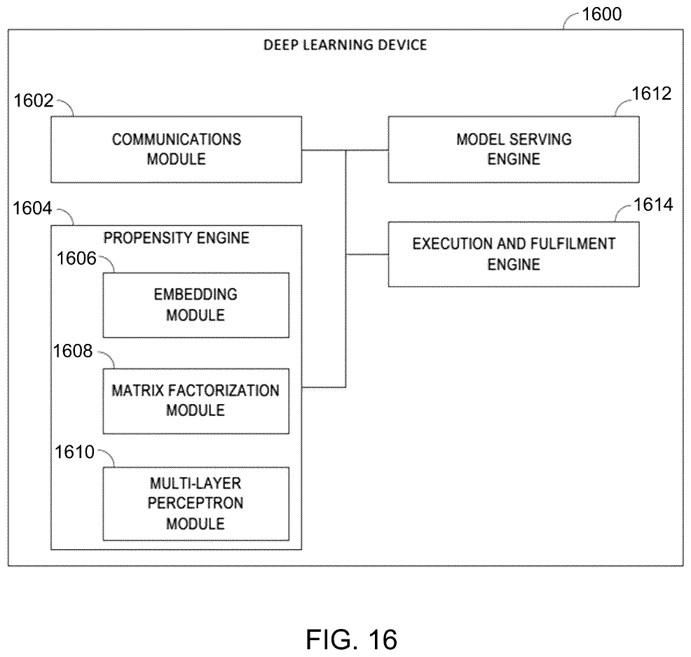

FIG. 8 illustrates a flow chart of an example method 800 for creating a model for individual users using AI/ML software of DCF computing system 102. Additional aspects of training and creation of user models of the AI/ML architecture of DCF computing system 102 are discussed below and shown in FIGS. 16-19.

Method 800 includes ingesting 802 of user data. This user data may include any of the user data discussed herein (e.g., transaction data, etc.). Method 800 further includes organizing 804 the ingested user data in data subsets. For example, the user data may be grouped by type (e.g., transaction data, UI preference data, etc.), helpful in assigning/defining corresponding parameters. Method 800 further includes selecting 806 subsets of the user data for review in connection with the user model. Method 800 further includes training 808 the model based on the selected subsets. Method 800 further includes evaluating 810 the model that includes the selected subsets. This may include, for example, evaluating the subsets relative to other aspects or parameters of the model, such as comparing the subsets to merchant rules that have also been input in the model. Method 800 further includes confirming 812 that the user model is performing as expected. This may include comparing outputs of the model to certain metrics or other benchmarks to ensure accuracy. Method 800 further includes deploying 814 the (e.g., updated) model for use as part of the DCF service provided by DCF platform 100. The steps of method 800 can also be used relative to any ingesting, organizing, selecting, training, evaluating, confirming, and deploying of any other aspects of any model of the DCF platform 100, including, for example, any rules/requirements set by a merchant or other entity (see FIG. 1) participating in the DCF platform 100.

FIG. 9 is an example illustration of a default browser-based checkout screen 900 displayed by a merchant on their website that may be used by a consumer (e.g., a user/candidate cardholder), to interface with merchant interface 122 via user computing device 124 (shown in FIG. 2). For example, default checkout screen 900 represents a checkout screen which has yet to be dynamically adjusted based on learned user preferences of the DCF service provided by DCF computing system 102. In the example embodiment, user interface 126 is presented on cardholder computing device 124 (shown in FIG. 2) and has interface aspects in operative communication with merchant system 120 and/or DCR computer system 102. Default checkout screen 900 may include a variety of information typically associated with a checkout process, including a user greeting 902, a payment method field 904 listing a variety of payment options 906, where payment options 906 may include various payment options such as payment via stored credit card information or payment via a digital wallet. Default checkout screen 900 may further include a shipping address field 908 includes a variety of contact information fields 910, where contact information fields 910 include fields to enter user information such as first name, last name, address, city, and country. Default checkout screen 900 may further include a shopping cart field 912, which lists information of the goods/services that have been added to the shopping cart of the merchant website. Shopping cart field 912 may include information including a text description and/or image (e.g., thumbnail) field 914 of the item present in the cart, a subtotal price field 916 of the item, fees (e.g., shipping costs) 918 associated with the item, and a total price field 920 of the item including the cost of the item (e.g., 916) and the shipping costs (e.g., 918). Default checkout screen 900 may further include a checkout button 922 to advance to a final checkout page once the information in fields 904 and 908 is successfully entered and payment is selected via icons of payment options 906. Default checkout screen 900 represents an implementation of the DCF service on a web browser of a desktop computer, but this is only for illustrative purposes and is not limiting. For example, prompts 312 (see FIG. 3B) may be realized as buttons of payment options 906 and checkout button 922.

FIG. 10 is an example illustration of a DCF-modified checkout screen 1000. DCF-modified screen 1000 is an example of how default checkout screen 900 may be modified once the DCF service learns the user's personal preferences and implements changes reflecting the learned user preferences to the user interface of the merchant checkout flow process. With reference to the example scenario reflected by FIG. 10, in operation, the DCF service learned that the user prefers a simplified checkout interface, and makes changes to cause a simplified user interface to be displayed to the user at checkout. The DCF-modified (e.g., model-defined) interface can be defined based on a plurality of user interface instructions resulting from the analysis of the (e.g., past and present (e.g., current) transaction data. DCF-modified checkout screen 1000 may include a reduced set of fields and/or other options (e.g., buttons) compared to default checkout screen 900. For example, DCF-modified checkout screen 1000 may include only (i) a greeting 1002, (ii) a fast-checkout payment button 1004 (e.g., linked to a payment method that the DCF service has learned the user prefers to use), where button 1004 also allows the user to “CHECKOUT NOW” (e.g., avoiding the need for a separate button such as checkout button 922 as shown in FIG. 9, based on learned user preferences learned by the DCF service), and (iii) a simplified cart field 1006, showing only the item description/image field 1008 and a total price field 1010 (because DCF service has learned the user will typically pay shipping costs and there is no need to display the shipping costs separately). For example, there may be an associated terms of service or other contract provided along with the DCF service, where the user, by virtue of using the merchant's website, agrees to be presented checkout information in the condensed formats that the DCF service is capable of portraying checkout information in (e.g., showing the total price inclusive of any shipping costs, without separately showing shipping costs (likewise for any taxes)). DCF-modified checkout screen 1000 represents an implementation of the DCF service on a web browser of a desktop computer, but this is only for illustrative purposes and is not limiting. For example, prompts 312 (see FIG. 3B) may be realized as button 1004.

FIG. 11 is an example illustration of an alternate DCF-modified checkout screen 1100. Alternate DCF-modified checkout screen 1100 represents an implementation of the DCF service that includes adding upsell opportunities that the merchant wants added to the checkout flow. For example, alternate DCF-modified checkout screen 1100 may include a greeting 1102, a primary item/image graphic 1104, an upsell graphic 1106, a quick purchase button 1108 that purchases both the (primary) item in 1104 and the upsell item associated with upsell graphic 1106, or an alternate purchase button 1110 that includes only the (primary) item in 1104 (e.g., does not also include the upsell item in 1106). Alternate DCF-modified checkout screen 1100 may also include a cart field 1112 that includes an item description/image field 1114, an item price field 1116 (which may or may not include extra fees such as shipping costs, if any), an upsell price field 1118, and a total price field 1120, which may list the total price of the item plus the cost of the upsell item. For example, alternate DCF-modified checkout screen 1100 represents an implementation of the DCF service that accommodates both the user's learned preferences and rules defined by the merchant. More specifically, FIG. 11 shows a scenario where the merchant may have instituted an upsell rule into the checkout process flow, so that the DCF service presents (e.g., via upsell graphic 1106 and/or upsell price field 1118) the user with an upsell option such as purchasing additional insurance during checkout. Or, the merchant may have made the upsell optional, but the DCF service determined the user is likely to respond well to upsells, and included an upsell option via 1106, 1108, and 1118. Alternate DCF-modified checkout screen 1100 can present a modified user interface that includes both a fast checkout button such as buttons 1108 and/or 1110 (which the DCF learned is preferred by the user), while also presenting the merchant's preferred goal/objective (such as upsell item 1106). Alternate DCF-modified checkout screen 1100 represents an implementation of the DCF service on a web browser of a desktop computer, but this is only for illustrative purposes and is not limiting. For example, prompts 312 (see FIG. 3B) may be realized as buttons 1108, 1110.

FIG. 12 is an example illustration of a screen displayed within a mobile application of a merchant, accessed via a mobile phone of a consumer (e.g., a user/candidate cardholder). For example, FIG. 12 represents a scenario when merchant user interface 122 (shown in FIG. 2) is accessed via user interface 126 of user computing device 124 in the case where user computing device 124 is a mobile phone (compared, for example, to FIGS. 9-11 where the user interface is in the form of a desktop computer web browser). FIG. 12 shows a mobile application screen 1200 that may be used by a cardholder to interface with merchant application (“app”) 1202 provided (at least in part) by merchant computer system 120 (shown in FIG. 2). DCF mobile application screen 1200 is similar to screen 1000 in FIG. 10 in that it represents a DCF-modified screen that displays checkout graphics that the merchant has provided to the DCF service and that the DCF service has learned the user prefers to see on a mobile device. For example, similar to screen 1000, screen 1200 includes a (fast) checkout button (e.g., 1208). DCF mobile application screen 1200 includes a heading field 1204 such as “CUSTOMER'S CART” (where “CUSTOMER” may be the first, last, full or alias/username name of the customer), an item description/image field 1206 that displays a text description (e.g., name) and/or image (e.g., thumbnail) of the item present in the cart, and a fast checkout button 1208 that may include pricing information and/or other information such as which user payment method (e.g., preferred credit card) the button 1208 will use for payment. The particular configuration of the user interface components of screen 1200 is the result of learned user preference/behavior by DCF computing system 102. This configuration is merely an example of how DCF computing system 102 may learn and dynamically adjust a user interface, and is not limiting. For example, prompts 312 (see FIG. 3D) may be realized as button 1208.

FIG. 13 is an example illustration of a screen displayed within a mobile application of a merchant, accessed via a mobile phone of a user. For example, FIG. 13 represents a scenario when user interface 126 (shown in FIG. 2) is accessed via user computing device 124 in the case where user computing device 124 is a mobile phone (compared, for example, to FIGS. 9-11 where merchant user interface is in the form of a desktop computer web browser). FIG. 13 shows a mobile application screen 1300 that may be used by a cardholder to interface with merchant application (“app”) 1302 provided (at least in part) by merchant computer system 120 (shown in FIG. 2). Mobile application screen 1300 represents another example of how the DCF service can dynamically adjust the checkout flow process to best accommodate a user's preferences, as learned by DCF computing system 102. DCF-modified screen 1300 displays both a fast checkout option and a full view of the cart in split-screen fashion on screen 1300. For example, left side 1304 of screen 1300 includes a heading 1306 such as “FAST CHECKOUT:” that presents a so-called “fast checkout” option to the user which has a reduced amount of visual information (compared, for example, to screen 900 of FIG. 9) but still provides a cost field 1308 for listing the price of the item, as well as payment method buttons 1310 (e.g., for payment via stored credit card information of the user) and 1312 (e.g., for payment via a digital wallet of the user). Right side 1314 of screen 1300 is separated visually from left side 1304 of screen 1300 by a graphic such as line 1316. Right side 1304 of screen 1300 presents the full cart to the user using a heading 1318 (e.g., “CART:”), and includes (i) an item description/image field 1320 (e.g., listing a text description of the item and/or an image of the item), (ii) a subtotal field 1322 (e.g. listing a subtotal price of the item), (iii) an extra fees field 1324 (e.g., listing fees such as shipping fees), (iv) a total cost field 1326 (e.g., listing the total cost of the item (e.g., the price in field 1322) plus any additional fees (e.g., fees in field 1324), and (v) a selectable button 1328 (e.g., “Proceed to checkout” button) to allow the user to proceed to a final checkout screen (not shown) of the checkout process. FIG. 13 represents a user interface on the mobile device that has been adjusted by the DCF service in accordance with the learned behavior/preferences of the user. For example, DCF computing system 102 may learn that a certain percentage of the time, the user does not utilize the “fast checkout” option (e.g., via buttons 1310, 1312), and instead prefers a full checkout experience (e.g., arrived at by selecting button 1328). The DCF service accordingly presents the user with both a fast checkout option and a standard checkout option to cater to the fact that the user tends to use one option or the other from time to time. Similarly, the DCF service may learn that the user sometimes pays with their stored credit card, and other times pays with their digital wallet. To account for this learned user behavior, screen 1300 presents two payment method buttons 1310 and 1312, where payment button 1310, when selected, will pay using the user's stored credit card, and payment button 1312, when selected, will pay using the user's digital wallet. For example, prompts 312 (see FIG. 3D) may be realized as buttons 1310, 1312, 1328.

FIG. 14 is an example illustration of a screen displayed within a merchant's in-store POS terminal. Screen 1400 may be arranged to show information in panes or quadrants, and for example is displayed when an item being purchased has had its barcode scanned. For example, in accordance with merchant rules, a merchant logo 1402 may be displayed in an upper left pane of screen 1400. Static or rolling advertisements for various offers/promotions (e.g., promos) may be displayed in a lower left pane of screen 1400 by way of promotion graphics 1404. Promotion graphics 1404 may include a plurality of different graphics programmed to cycle through different graphics associated with different promotions according to a defined schedule (e.g., any one graphic of promotion graphics 1404 may show on the display of the POS terminal for about 10 seconds and then change to a different graphic associated with a different promotion). Promotion graphics 1404 are similar to upsell graphic 1106 shown in FIG. 11, and may be displayed by the DCF service on screen 1400 in accordance with rules set by the merchant. For example, the merchant may want to emphasize store credit card signups for a particular period, and promotion graphics 1404 can be set by the DCF service to emphasize the store credit card signup goals of the merchant (e.g., “SAVE 30%”, “OPEN A STORE CREDIT CARD”). A right pane of screen 1400 may include sales information for the item being purchased, as well as other information relevant to the in-store purchaser. The right pane may include an item description/image section 1406 including a text description (e.g., name) and/or an image (e.g., thumbnail) of the item being purchased. Additional information may be presented in various fields of the right pane, including a price field 1408 displaying a price of the item being purchased, a fees (e.g., taxes) field 1410 showing any applicable fees or taxes of the item being purchased, a total amount field 1412 showing the total amount needing to be paid to purchase the item. The right pane of screen 1400 may also include option graphics 1414 to present the purchaser with additional options relating to their purchase, such as the option to pay for all or some of the purchase price using rewards points associated with a rewards account the purchaser has with the particular merchant. For example, prompts 312 (see FIG. 3C) may be realized as buttons for graphics 1404, 1414.

FIG. 15 is an example illustration of an alternative screen displayed within a merchant's in-store POS terminal. Screen 1500 is similar to screen 1400 shown in FIG. 14, except that screen 1500 displays a DCF-modified screen that has been adjusted to cater to an in-store purchaser that, based on their learned spending pattern, tends to always use their rewards points to pay for purchases. Screen 1500 may be arranged to show information in panes or quadrants, for example when an item being purchased has its barcode scanned. For example, a merchant logo 1502 may be displayed in an upper left pane of screen 1500 in accordance with merchant rules. Static or rolling advertisements for various offers/promotions (e.g., promos) may be displayed in a lower left pane of screen 1500 by way of promotion graphics 1504 and 1506. Promotion graphics 1504 may include graphics pertaining to a long-term or long-standing offer that is generally always offered by the merchant. For example, promotion graphics 1504 may correlate to certain savings percentage available when a consumer signs up for and uses a store credit card when making a first purchase. Promotion graphics 1506 may include a plurality of different graphics programmed to cycle through different graphics associated with various short-term and/or seasonal promotions according to a defined schedule (e.g., any one graphic of promotion graphics 1504/1506 may show on the display of the POS terminal for about 10 seconds and then change to a different graphic associated with a different promotion). Promotion graphics 1504 and 1506 are similar to upsell graphic 1106 shown in FIG. 11 and promotion graphics 1404 in FIG. 14, and may be displayed by the DCF service on screen 1500 in accordance with rules set by the merchant. A right pane of screen 1500 may include sales information for the item being purchased, as well as other information relevant to the in-store purchaser. The right pane may include an item description/image section 1508 including a text description (e.g., name) and/or an image (e.g., thumbnail) of the item being purchased. Additional information may be presented in various fields of the right pane, including a price field 1510 displaying a price of the item being purchased, a fees (e.g., taxes) field 1512 showing any applicable fees or taxes of the item being purchased, a total amount field 1514 showing the total amount needing to be paid to purchase the item. However, compared to similar fields 1408, 1410, and 1412 in FIG. 14, fields 1510, 1512, and 1514 in FIG. 15 illustrate how DCF computing system 102 can display custom interfaces on a per-user basis based on the learned behavior of the user. More specifically, while fields 1408, 1410, and 1412 in FIG. 14 show the price in dollars, fields 1510, 1512, and 1514 in FIG. 15 show the price in rewards points. FIG. 15 illustrates DCF computing system 102 having learned that the particular user prefers to pay in-store using rewards points. The right pane of screen 1500 may also include option graphics 1516 to present the purchaser with additional options relating to their purchase, such as the option to view their remaining rewards points. Given that screen 1500 has been modified by DCF computing system 102 to offer payment in rewards points currency instead of cash/credit, screen 1500 may include additional option graphics 1518, directed to using other payment forms (e.g., cash). For example, option graphics 1518 may be tailored to reflect the user's second most preferred payment form (e.g., cash), whereas the other fields (e.g., 1510 and 1514) and option graphics (e.g., 1516) are directed to the most preferred payment method (e.g., rewards points), as determined by the DCF computing system 102. For example, prompts 312 (see FIG. 3C) may be realized as buttons for graphics 1504, 1506, 1516, 1518.

With reference to FIGS. 9-15, items associated with fields/buttons 914, 1008, 1104, 1114, 1206, 1320, 1406, 1508 may be referred to as a primary item(s) of interest of the purchaser. The example screens and user interface components shown in FIGS. 9-15 are not limiting and instead serve to illustrate the numerous ways the DCF service can dynamically adjust screen layouts and/or user interface components in any configuration (e.g., desktop, in-app, POS terminal) in a tailored manner to best match learned user preferences/behaviors. The user will reap the benefits of the customized experience, and the merchant will reap the benefits of increased engagement and/or retention of the user. As shown in FIGS. 9-15, user interface components on the display screens of the various devices (e.g., desktop computer, mobile phone, POS terminal) can be individually set based on user preference, thereby providing for a tailored appearance on a per-device level. Each device may have its own device-specific user interface, as determined by DCF computing system 102 based on user preference determinations.

Moreover, the features of the display screens shown in FIGS. 9-15 can be viewed in combination to provide further disclosure of the dynamic capabilities of DCF computing system 102 disclosed herein. For example, for a User A that makes purchases at Merchant A, DCF computing system 102 might learn that User A prefers the user interface configuration shown on screen 1200 in FIG. 12 for purchases made on their mobile phone, but prefers the user interface configuration shown on screen 1500 in FIG. 15 for in-store purchases made at a POS terminal. When comparing the differences between the user interface configurations in FIGS. 12 and 15, it is apparent that DCF computing system 102 learned that User A prefers a simplified visual interface and to pay via credit card when using their mobile phone, but prefers to pay with rewards points of Merchant A when making in-store purchases, and has also responded well in the past to being presented with various promotions such as via (e.g., seasonal) promotion graphics 1506 when making in-store purchases.

Further nuance may be detected, learned, and put into action by DCF computing system 102 for User A. For example, despite the fact User A is a loyal shopper at Merchant A (as evidenced by User A's accumulation and frequent use of rewards points of Merchant A), DCF computing system 102 learns that User A has never signed up for the store credit card of Merchant A. DCF computing system 102 may learn from other User A behavior (e.g., from offers redeemed by User A at other merchants participating in DCF computing system 102) that User A only responds positively to very large savings offers. As such, for User A, a standard offer of saving 30% on a first purchase via the store credit card at Merchant A (see promotion graphic 1404 in FIG. 14) has never been substantial enough to convince User A to sign up for the store credit card for Merchant A. Accordingly, DCF computing system 102 may present different offers for User A regarding the savings promotion tied to the store credit card signup at Merchant A, as permitted by merchant rules. For example, as shown in FIG. 15, promotion graphic 1504 may present User A with a 60% savings on a first purchase made using the store credit card (much higher than the standard 30% savings (see promotion graphic 1404 in FIG. 14)). Accordingly, for the very same user (e.g., User A), DCF computing system 102 learns to (i) present two entirely different user interfaces depending, for example, on how and/or where the purchase is being made (e.g., mobile vs. in-store purchases), and (ii) present the user with user-specific offers that may entice the user to take certain actions that the user has declined to take in the past. Additionally, as shown by graphics 1404, 1504, and 1506 in FIGS. 14 and 15, DCF computing system 102 implements the merchant's sales goals/objectives by displaying the various merchant promotions to the user.

Additional non-limiting examples of how DCF computing system 102 can be utilized to provide custom checkout interfaces are provided below. A first additional example is a case where a user is purchasing (or renting) a 3D printer, and, based on past user transaction data and/or learned user preferences, DCF computing system 102 presents a checkout interface that includes an upsell item, such as filament for the 3D printer. For example, DCF computing system 102 would know that the user has responded favorably to such upsell offers in the past, and would likely respond favorably again to the filament upsell for the 3D printer. DCF computing system 102 would then generate a checkout interface similar to that in FIG. 11 (e.g., filament would be associated with upsell graphic 1106, and the “checkout now” button 1108 would allow for purchase of both the 3D printer and the filament via one easy click, consistent with past offers the user has responded favorably to). A second additional example is a case where a user is renting a car, and is presented with insurance/coverage options as part of the checkout process of renting the car. Based on past user transaction data and/or learned user preferences, DCF computing system 102 would know that the user has accepted certain coverage (e.g., collision damage coverage) in the past, but has typically declined certain other coverage(s) (e.g., roadside assistance). DCF computing system 102 would then present to the user coverage options consistent with those stored in a user model for the particular user. This would improve the user's experience at this particular rental car merchant by not having to take the time to decline options they have consistently declined in the past, creating a more personal and tailored checkout process, and increasing user loyalty for that particular rental car merchant. The rental car merchant would get value out of the DCF service provided by the DCF provider due to the benefits of a more satisfied customer that is more likely to stay loyal to them and/or increase purchases through them.

FIG. 16 is a component diagram of deep learning device 1600 of DCF platform 100 in one example embodiment. Deep learning device 132 shown in FIG. 2 may be realized as deep learning device 1600. In the example embodiment, deep learning device 1600 may be present as part of DCF computing system 102, and include communications module 1602, a propensity engine 1604, a model serving engine 1612, and an execution and fulfilment engine 1614 which, together, perform various aspects of the learning of a user's preferences and behaviors described herein, making of user models, and applying rules of the merchant in connection with generating dynamic checkout flows that capture and present both merchant goals/objectives and preferences of the user. More specifically, communications module 1602 is configured to perform various communication functionality between deep learning device 1600 and other computing devices, such as server 114 and other computing devices of the DCF platform 100 (e.g., DCF computing system 102, merchant computing device 120, user computing device 124, database 130). For example, communications module 1602 may be configured to receive input data (e.g., from database server 114) for the various inputs used to create the user models described herein, or to transmit recommendation results of applications of those models (e.g., to client computing devices 120, 124).

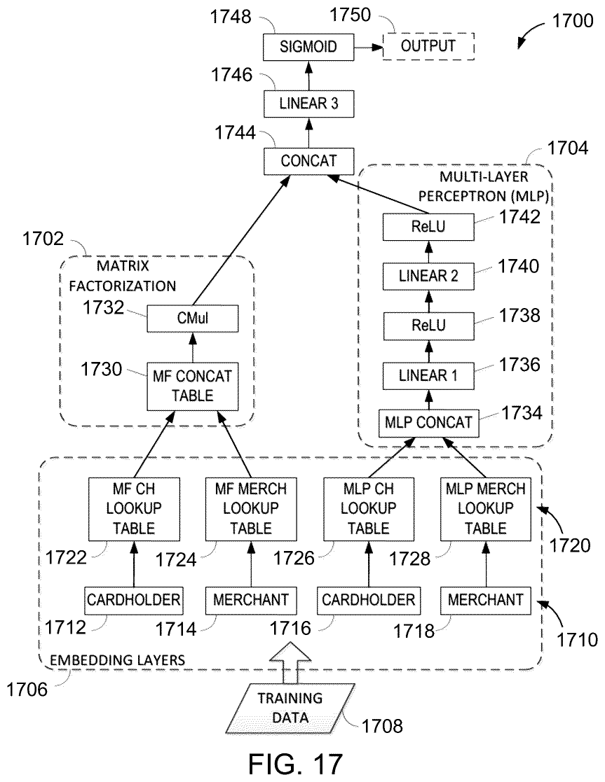

Propensity engine 1604 is configured to train deep learning models, using various input data, which can then be used to generate DCF-modified UI's as described herein and shown in FIGS. 10-15, for example. In the example embodiment, the propensity engine 1604 includes an embedding module 1606, a matrix factorization module 1608, and a multi-layer perceptron module 1610 that, together, implement neural collaborative filtering (NCF) techniques as described herein. Embedding module 1606 performs aspects of data input acquisition, preparation, and staging (e.g., feature preparation). Matrix factorization module 1608 performs the matrix factorization steps of model building associated with NCF and multi-layer perceptron module 1610 performs the multi-layer perceptron steps of model building associated with NCF. Additional detail associated with application of NCF is provided below with respect to FIG. 17.

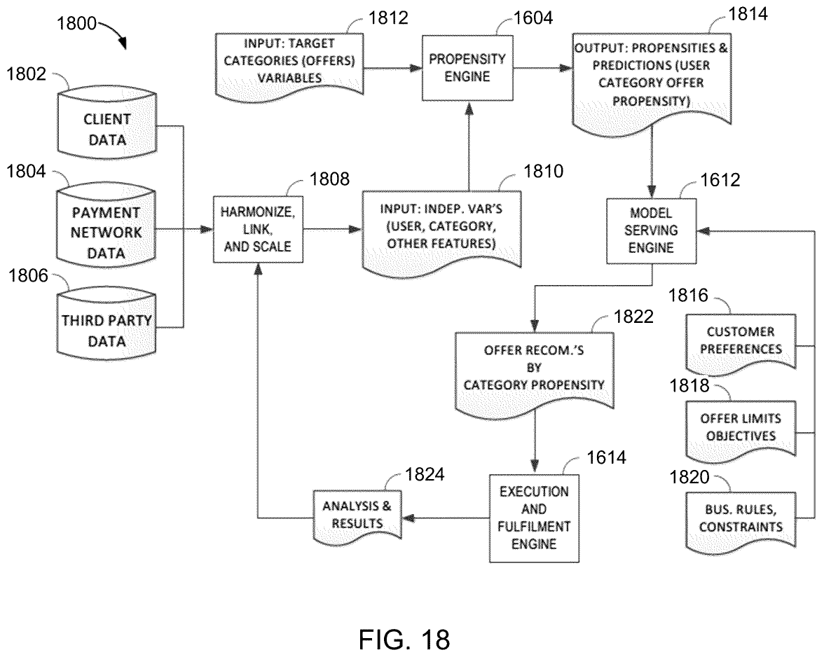

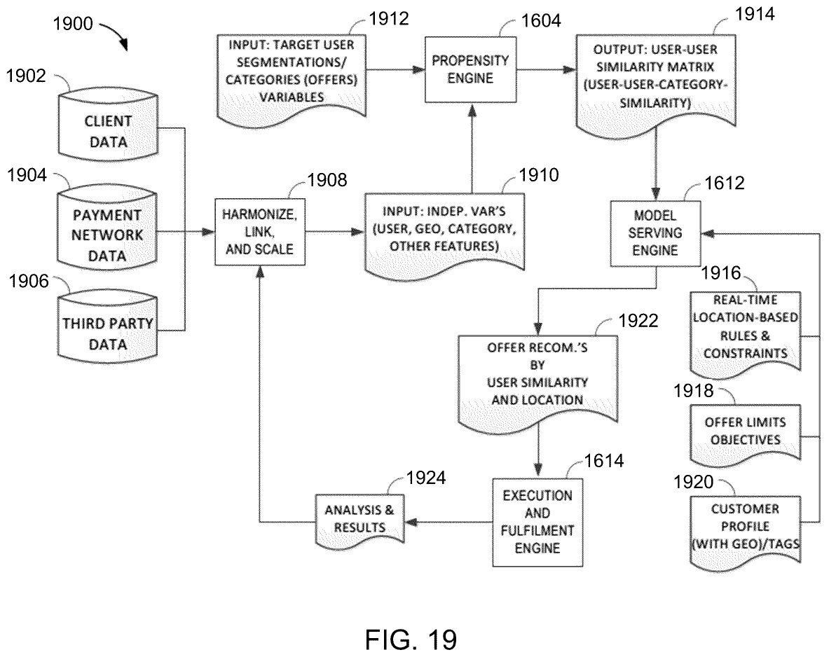

Model serving engine 1612 applies the models built by propensity engine 1604 and used by DCF computing system 102 to generate various DCF-modified UI's that implement merchant goals/objectives and cardholder preferences as described herein (e.g., using aspects of merchant guidelines and cardholder data as inputs to the model). Model serving engine 1612 may use inputs such as (i) merchant rules regarding the display of limited time offers and promotions at checkout, (ii) other business rules and constraints of the merchant, (iii) historical transaction data of the user, and (iv) customer preference data. In the example embodiment, model serving engine 1612 is illustrated as a part of deep learning device 1600. In other embodiments, the models built by propensity engine 1604 may be deployed to or otherwise accessible from other computing devices in the DCF platform 100, such as server system 114. Execution and fulfilment engine 1614 presents the personalized DCF-modified UI to cardholders through various venues, as well as captures new user behavior such as offer activation data for offers the user accepts (e.g., which offers were acted upon by the offeree cardholder, how the offeree cardholder acted upon the offer, and so forth). Aspects of operation of model serving engine 1612 and execution and fulfilment engine 1614 are discussed in greater detail below with respect to FIGS. 18 and 19.

FIG. 17 is a diagram illustrating various operating components of a neural recommender model 1700 trained and implemented by deep learning device 1600 in DCF computing system 102. In the example embodiment, neural recommender model 1700 implements neural collaborative filtering and is configured to evaluate cardholder behavior propensity, for example the user's propensity to activate offers from particular merchants, utilize certain payment methods over others, and various other exhibited behaviors and preferences. Neural recommender model 1700 is a multi-layer representation that models user-item (e.g., cardholder-merchant) interactions, where the output of one layer is used as the input of the next layer (e.g., in an upward flow, as shown in FIG. 17). Neural recommender model 1700 includes embedding layers 1706 where training data 1708 is staged for use by both matrix factorization (MF) 1702 and a multi-layer perceptron (MLP) 1704. Training data 1708 may include historical transaction data of a user, data from merchant-managed accounts of the user, and any other data or information pertaining to the user that would be beneficial in building a user preference model specific to that individual user. Once trained, neural recommender model 1700 generates propensities for cardholders 22 to take certain actions, such as activate offers for particular goods/services (e.g., choosing to purchase insurance for an item), using one payment method over another, using one login or authentication mechanism over another, and more.

In the example embodiment, during training and configuration of neural recommender model 1700, neural recommender model 1700 begins in an unconfigured state with generating an input layer 1710 from training data 1708 (e.g., transaction information, authentication information, and offer acceptance information). More specifically, deep learning device 1600 creates input components 1712, 1714, 1716, 1718 of input layer 1710 from training data 1708 (separately illustrated as cardholder data 1712, 1716 and merchant data 1714, 1718). A sample typically consists of three parts: label, feature, and a sample ID. The sample ID is the identifier of a particular sample. The training process is the process of learning the label through the feature. The label can be a single value (e.g., two classification) or multiple values (e.g., multi-classification). Each sample can be represented in the form of a vector (e.g., image features, gender information of the cardholder, and so forth). Traditional features are typically dense, and the dimensions are not particularly high. In the example embodiment, there are a large number of sparse features associated with cardholder and payment card network data. These feature dimensions are high (e.g., tens of millions), but the number of occurrences in each sample is low (e.g., hundreds), and such features are sparsely represented in multiple key-value ways (e.g., merchant category (where key is the ID of the category and with no value), list of merchants that the user visited (where key is the merchant ID and value is the number of visits)). Features may be organized in the form of feature groups to facilitate the construction of training networks. For example, features may be: category (dense features), user identity (sparse features), merchant (sparse features), spend amount (dense features).

In the example embodiment, deep learning device 1600 constructs an embedding layer 1720 from the input layer 1710. More specifically, embedding layer 1720 includes lookup tables, for example lookup tables 1722, 1724, to be used for matrix factorization 1702 and lookup tables 1726, 1728 to be used for multi-layer perceptron 1704. Deep learning device 1600 constructs lookup tables 1722, 1726 for cardholder information from the cardholder input components 1712, 1716, respectively, as well as lookup tables 1724, 1728 for merchant information from for the merchant input components 1714, 1718, respectively. In some embodiments, lookup tables 1722, 1724, 1726, 1728 are the output of the encoding/indexing process. Deep learning device 1600 builds a model fitted by a transformer. For example, deep learning device 1600 builds StringIndexModel for users and items via the Spark API spark-mllib-StringIndexer (as provided by Apache Spark). After the StringIndex model is generated, they will be mapped to the LookupTable structure (e.g., from Intel BigDL):

```
object LookupTable {
  def apply[@specialized(Float, Double)T: ClassTag](
    nIndex: Int, nOutput: Int,
    paddingValue: Double = 0, maxNorm: Double = Double.MaxValue,
    normType: Double = 2.0, shouldScaleGradByFreq: Boolean = false,
    wRegularizer: Regularizer[T] = null,
    maskZero: Boolean = false
  )
  (implicit ev: TensorNumeric[T]): LookupTable[T] =
    new LookupTable[T](nIndex, nOutput, paddingValue,
    maxNorm, normType, shouldScaleGradByFreq, wRegularizer,
    maskZero)
}
```

Deep learning device 1600 may use various methods of NCF. In one embodiment, two methods of NCF are used, namely matrix factorization (MF) 1702 in conjunction with multi-layer perceptron (MLP) 1704. MF 1702 and MLP 1704, in the example embodiment, learn separate embeddings in embedding layers 1706, but combine the two models in their last hidden layer. More specifically, deep learning device 1600 uses cardholder lookup table 1722 and merchant lookup table 1724 for matrix factorization 1702, and uses cardholder lookup table 1726 and merchant lookup table 1728 for multi-layer perceptron 1704. For MF 1702, the two lookup tables 1722, 1724 are concatenated into an MF concatenated table 1730. MF 1702 may use one hidden layer, CMul 1732, in matrix factorization processing. For example:

```
def getBigDLModel(
  ulimit: Int, uOutput: Int,
  mlimit: Int, mOuput: Int,
  params: AppParams,
  featureDimension: Int): Module[Float] = {
  val initialWeight = 0.5
  // construct LookupTable for user
  val user_table = LookupTable(ulimit, uOutput)
  // construct LookupTable for item
  val item_table = LookupTable(mlimit, mOuput)
  // set weights parameter ( random way) to all the LookupTable
  user_table.setWeightsBias(Array(Tensor[Float](ulimit,uOutput).randn(0,
    initialWeight)))
  item_table.setWeightsBias(Array(Tensor[Float](mlimit,mOuput).randn(0,
    initialWeight)))
  // how many extra dense features
  val numExtraFeature = featureDimension − 2
  // contact MF features together to be CMul hidden layer
  val embedded_layer = if (numExtraFeature > 0) {
    Concat(2)
      .add(Sequential( ).add(Select(2, 1)).add(user_table))
      .add(Sequential( ).add(Select(2, 2)).add(item_table))
      .add(Sequential( ).add(Narrow(2, 3, numExtraFeature)))
  } else {
    Concat(2)
      .add(Sequential( ).add(Select(2, 1)).add(user_table))
      .add(Sequential( ).add(Select(2, 2)).add(item_table))
  }
  // use Sequentical model structure
  val model = Sequential( )
  // add CMul layer to model
  model.add(embedded_layer)
  // construct MLP hidden layers
  val numEmbeddingOutput = uOutput + mOuput + numExtraFeature
  val linear1 = math.pow(2.0, (math.log(numEmbeddingOutput) /
    math.log(2)).toInt).toInt
  val linear2 = linear1 / 2
  model.add(Linear(numEmbeddingOutput,
  linear1)).add(ReLU( )).add(Dropout( ))
  model.add(Linear(linear1, linear2)).add(ReLU( ))
  // Concate the CMul and MLP hidden layers and adopt logSoftMax
  activation functions to predict final output layer
  model.add(Linear(linear2, 2)).add(LogSoftMax( ))
  if (params.debug) {
    println(model)
  }
  model
}
```

For MLP 1704, deep learning device 1600, in the example embodiment, the two lookup tables 1726, 1728 are concatenated into an MLP concatenated table 1734. MLP 1704 may use two hidden layers, “Linear 1” 1736 and “Linear 2” 1740, for the multi-layer perceptron processing, along with subsequent rectifiers ReLU (rectified linear unit) 1738, 1742. CMul 1732 and ReLU 1742 may be used for Concat function 1744. In the example embodiment, MF 1702 and MLP 1704 share “Linear 3” 1746 as their last hidden layer, which in turn is fed to Sigmoid function 1748 to generate output 1750.

FIG. 18 is a data flow diagram illustrating a process 1800 and associated data for identifying aspects of cardholder preferences, such as to receive offers from a particular category offered by the merchant. In the example embodiment, process 1800 is performed by the various components of deep learning device 1600 with data from computing systems of DCF platform 100, such as merchant system 120 and/or payment network server 116 using the NCF techniques described above. Deep learning device 1600 may use client data 1802 (e.g., data 306, 316), payment network data 1804 (e.g., data 308, information 314), and/or third party data 1806 (e.g., data 310) as inputs to harmonize, link, and scale 1808 the inputs into independent variables 1810 (e.g., user, category, and other features). Inputs 1810 are used in model training by propensity engine 1604, along with input 1812 of target categories (e.g., offers) variables. Propensity engine 1604 uses the NCF techniques described above with respect to FIG. 17 to generate propensities and predictions (e.g., user category offer propensity) model 1814.

Model serving engine 1612, in the example embodiment, uses model 1814, along with inputs of customer preferences 1816, offer limits and objectives 1818, and business rules and constraints 1820, to generate individualized checkout flows by category propensity 1822. Execution and fulfilment engine 1612 acts on propensity 1822 by presenting selecting and presenting offers to cardholders based on propensity 1822. Analysis and results 1824 may be generated and provided back into the process 1800 (e.g., to inform subsequent model generation). While FIG. 18 focus on aspects relating to offers, the same process can be performed for other aspects of building a user-specific model as described herein. For example, the techniques of FIG. 18 can be applied for user preferences such as payment method preferences, login/authentication preferences, UI preferences, etc.

FIG. 19 is a data flow diagram illustrating a process 1900 and associated data for an additional aspect of utilizing user preferences to present dynamic interfaces to users, namely user preferences while traveling. For example, FIG. 19 illustrates how DCF computing system 102 can be used to generate dynamic information for presentation to a user in a variety of circumstances (e.g., circumstances outside of the user making purchases at their local merchant in-store location, or at home via their normal computing device). Process 1900 identifies merchants or categories which a cardholder may like when in a different location (e.g., while traveling), based on past transaction data of the user and other learned user preferences. In the example embodiment, process 1900 is performed by the various components of deep learning device 1600 with data from computing systems of DCF platform 100, such as merchant system 120 and/or payment network server 116 using the NCF techniques described above. Deep learning device 1600 may use client data 1902 (e.g., data 306, 316), payment network data 1904 (e.g., data 308, information 314), and/or third party data 1906 (e.g., data 310) as inputs to harmonize, link, and scale 1908 the inputs into independent variables 1910 (e.g., user, geography, category, and other features). Inputs 1910 are used in model training by propensity engine 1604, along with input 1912 of target user segmentations/categories (offers) variables. Propensity engine 1604 uses the NCF techniques described above with respect to FIG. 17 to generate user-user similarity matrix 1914 (e.g., user-user category similarity).

Model serving engine 1612, in the example embodiment, uses matrix 1914, along with inputs of real-time location-based rules and constraints 1916, offer limits and objectives 1918, and customer profile (with geolocation data) 1920, to generate offer recommendations 1922 by user similarity and location. Execution and fulfilment engine 1612 acts on offer recommendations 1922 by presenting selecting and presenting offers to cardholders based on offer recommendations 1922. Analysis and results 1924 may be generated and provided back into process 1900 (e.g., to inform subsequent model generation). While FIG. 19 focus on aspects relating to offers in a travel context, the same process can be performed for other aspects of building a user-specific model as described herein. For example, the techniques of FIG. 19 can be applied for user preferences such as payment method preferences, login/authentication preferences, UI preferences, etc. The embodiment of FIG. 19 may also provide benefits in the fraud detection/prevention application described herein. For example, certain fields of a checkout interface may be determined and set by rules of the merchant and/or another entity (e.g., merchant bank 26, issuer 30) participating in the DCF platform to be mandatory based on user location. The DCF computing system 102 would adjust the checkout interface as needed to ensure the location-based fraud prevention rules are followed (e.g., the user is presented with the necessary fields as part of the checkout process). For example, if the AI/ML of DCF computing system 102 knows that a user prefers to enter a pin to authenticate, but has detected that the user is having trouble remembering their pin (e.g., multiple failed attempts), DCF computing system 102 can offer up a separate authentication mechanism to allow for login without the pin.

While the dynamic adjustments made via the DCF computing system are disclosed herein as being applied to merchant checkout interfaces, the techniques disclosed herein can be applied to a plurality of situations, and as such this disclosure is not limited only to checkout interfaces in the context of purchases. For example, the same techniques used herein to dynamically adjust a checkout interface may be used to dynamically adjust log-in interfaces. More generally, the dynamic adjustment techniques disclosed herein may be utilized to dynamically adjust any user interface that would benefit from dynamically adjusting the user interface to reflect individualized information of a user/viewer of the interface. For example, similar to the travel-centric embodiment shown in FIG. 19, a dynamic UI-adjusting computing system similar to the DCF computing system disclosed herein could be utilized in an airport check-in setting, such as via a security kiosk that uses biometric (e.g., fingerprint, facial) recognition to expedite check-in or boarding at an airport. Such a dynamic UI-adjusting system may know from past data and past learned user behavior that the user always purchases a beverage (e.g., coffee) after passing through security but before their plane departs. After the security kiosk processes the user for check-in (e.g., via biometric authentication) the dynamic UI-adjusting system may augment a display screen of or associated with the security kiosk to show locations of stores that sell beverages, or even provide a quick purchase button on-screen, providing the option for the user to select the on-screen quick purchase button to order a beverage via the display screen of or associated with the security kiosk. The user can then navigate from the security kiosk to the store to pick up the beverage ordered at the security kiosk. This would represent a great convenience to the user (e.g., traveler).

Further, with respect to implementing the DCF service in other sales/purchase contexts, such as digital transactions, additional examples are presented below. For example, in a video game context, the DCF service may prompt a proposed transaction for a player, for example, needs additional help or support on overcoming a particular obstacle in the video game. For example, if a player has failed to proceed past a certain level in the video game, a prompt may be generated within the game to ask the player if they would like to purchase a certain item or other feature to assist in getting the player past the point in which they are stuck. The prompt may, for example, offer an extra life in the video game for a certain fee. By virtue of the underlying machine learning aspects of the DCF service, the DCF service may learn how many times the player needs to lose before they will consider making an in-game purchase that will help them advance in the video game. For example, the DCF service over time may learn (e.g., via machine learning) that the player will not buy an extra life after only six failed attempts to progress past a certain level of the video game but will consider buying an extra life after ten failed attempts. In the VR context, a joystick controller may be associated with control of the VR headset. A user may assign a certain joystick movement combination (e.g., left, right, up, down) as a means to enable purchases via the VR digital storefront. The VR headset recognizes this joystick combination as an authorization to proceed with a purchase. The DCF system herein can also learn these types of purchase behaviors.

Moreover, while the DCF service is intended to learn user behavior and preferences either without direct knowledge of the user and/or in a passive manner undetectable by the user, other embodiments may include providing a user portal where the user can enter their own desired preferences relating to aspects such as transactions, advertisements, and promotional offers, and the DCF service will further learn from and update the user's model based on the user-entered preferences entered into the user portal. For example, a merchant or the DCF provider may make available to users a website that users can log into to define their preferences. Accordingly, the DCF service can learn independent of direct input of a user, or in conjunction with direct input from a user.

The term processor, as used herein, refers to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are exemplary only, and are thus not limiting as to the types of memory usable for storage of a computer program.

As will be appreciated based on the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, e.g., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications or code) include machine instructions for a programmable processor and can be implemented in a high-level procedural and/or object-oriented programming language, and/or in assembly/machine language. As used herein, the terms “machine-readable storage medium” and “computer-readable storage medium” refer to any computer program product, apparatus and/or device (e.g., magnetic discs, optical disks, memory, Programmable Logic Devices (PLDs)) used to provide machine instructions and/or data to a programmable processor, including a machine-readable storage medium that receives machine instructions as a machine-readable signal. The term “machine-readable signal” refers to any signal used to provide machine instructions and/or data to a programmable processor. The machine-readable storage medium and computer-readable medium do not include transitory signals.

The above-described embodiments of a method and system of ranking merchants according to a cardholder's preferences and purchasing behaviors provides a cost-effective and reliable means for maintaining contact with a customer by merchants and a network interchange provider. As a result, the methods and systems described herein facilitate leveraging a payment network's assets to engage cardholders and merchants in an enhanced purchasing experience in a cost-effective and reliable manner.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computer system for providing a dynamic purchase experience to a candidate cardholder, said computer system comprising:
at least one memory device for storing data; and
at least one processor in communication with said at least one memory device, said at least one processor programmed to:
receive current transaction data of the candidate cardholder from a current transaction of the candidate cardholder at a candidate merchant, the candidate merchant being part of a plurality of merchants;
process the current transaction data to generate a plurality of candidate parameters;
retrieve merchant instructions defining a plurality of merchant parameters, the plurality of merchant parameters being associated with a plurality of transaction processes;
compare the plurality of candidate parameters and the plurality of merchant parameters to a plurality of model parameters of a purchase model, the purchase model being specific to and associated with the candidate cardholder;
identify a parameter association between (i) any of the plurality of candidate parameters, (ii) any of the plurality of merchant parameters, and (ii) any of the plurality of model parameters;
generate, based on the parameter association, a set of user interface instructions; and
cause, via a computing device associated with the candidate cardholder, a model-defined user interface relating to the parameter association to be presented to the candidate cardholder during the current transaction via a display screen of the computing device, the model-defined user interface being defined by the user interface instructions.

2. A system in accordance with claim 1, wherein said at least one processor is further programmed to:
receive purchase activity data of the candidate cardholder, the purchase activity data including purchase data from a plurality of purchases made by the candidate cardholder at the plurality of merchants;
store the purchase activity data in a database associated with the computer system;
process the purchase activity data in accordance with model rules associated with the purchase model;
identify from the purchase activity data a plurality of purchase factors of the candidate cardholder;
create candidate cardholder preference parameters based at least in part on the plurality of purchase factors of the candidate cardholder, wherein the candidate cardholder preference parameters represent a level of preference of the candidate cardholder for at least one aspect of a purchase checkout process; and
train the purchase model with the candidate cardholder preference parameters.

3. A system in accordance with claim 2, wherein said at least one processor is further programmed to:
update the purchase model with new tracked purchase activity of the candidate cardholder;
generate new candidate cardholder preference information as part of an updated output of the purchase model; and
apply the updated output of the purchase model to analyze a next transaction of the candidate cardholder.

4. A system in accordance with claim 1,
wherein the model-defined user interface comprises a layout of visual components of a purchase checkout interface of the candidate merchant and the components includes one or more of (i) contact information fields, (ii) payment options, and/or (iii) offers presented by the candidate merchant to the candidate cardholder.

5. A system in accordance with claim 4,
wherein the offers comprise upsell offers of the candidate merchant associated with a primary item of interest of the candidate cardholder within the purchase checkout interface of the current transaction.

6. A system in accordance with claim 1, wherein said computing device is (i) a desktop or laptop computer associated with the candidate cardholder, (ii) a mobile device associated with the candidate cardholder, or (iii) a point-of-sale (POS) terminal associated with the candidate merchant.

7. A system in accordance with claim 6, wherein said at least one processor is further programmed to:
present a device-specific model-defined user interface on a display screen of each of (i) the desktop or laptop computer associated with the candidate cardholder, (ii) the mobile device associated with the candidate cardholder, and (iii) the POS terminal associated with the candidate merchant, the device-specific model-defined user interface being different for each of (i) the desktop or laptop computer associated with the candidate cardholder, (ii) the mobile device associated with the candidate cardholder, and (iii) the POS terminal associated with the candidate merchant.

8. A system in accordance with claim 1, wherein said at least one processor is further programmed to:
receive at least one manual selection made by the candidate cardholder during the current transaction.

9. A system in accordance with claim 1, wherein said at least one processor is further programmed:
to interface between the candidate cardholder using the computing device and a merchant computing device of the candidate merchant.

10. A system in accordance with claim 9, wherein to interface between the candidate cardholder and the merchant computing device, said at least one processor is programmed to at least one of enable the candidate merchant to communicate offers to the candidate cardholder, and display account information of the candidate cardholder.

11. A system in accordance with claim 1, wherein the plurality of merchants are associated with the same market segment.

12. A computer-implemented method for providing a dynamic purchase experience to a candidate cardholder using at least one processor in communication with at least one memory, the method comprising:
receiving current transaction data of the candidate cardholder from a current transaction of the candidate cardholder at a candidate merchant, the candidate merchant being part of a plurality of merchants;
processing the current transaction data to generate a plurality of candidate parameters;
retrieving merchant instructions defining a plurality of merchant parameters, the plurality of merchant parameters being associated with a plurality of transaction processes;
comparing the plurality of candidate parameters and the plurality of merchant parameters to a plurality of model parameters of a purchase model, the purchase model being specific to and associated with the candidate cardholder;
identifying a parameter association between (i) any of the plurality of candidate parameters, (ii) any of the plurality of merchant parameters, and (ii) any of the plurality of model parameters;
generating, based on the parameter association, a set of user interface instructions; and
causing, via a computing device associated with the candidate cardholder, a model-defined user interface relating to the parameter association to be presented to the candidate cardholder during the current transaction via a display screen of the computing device, the model-defined user interface being defined by the user interface instructions.

13. A computer-implemented method in accordance with claim 12, said method further comprising:
receiving purchase activity data of the candidate cardholder, the purchase activity data including purchase data from a plurality of purchases made by the candidate cardholder at the plurality of merchants;
storing the purchase activity data in an associated database;
processing the purchase activity data in accordance with model rules associated with the purchase model;
identify from the purchase activity data a plurality of purchase factors of the candidate cardholder;
creating candidate cardholder preference parameters based at least in part on the plurality of purchase factors of the candidate cardholder, wherein the candidate cardholder preference parameters represent a level of preference of the candidate cardholder for at least one aspect of a purchase checkout process; and
training the purchase model with the candidate cardholder preference parameters.

14. A computer-implemented method in accordance with claim 13, said method further comprising:
updating the purchase model with new tracked purchase activity of the candidate cardholder;
generating new candidate cardholder preference information as part of an updated output of the purchase model; and
applying the updated output of the purchase model to analyze a next transaction of the candidate cardholder.

15. A computer-implemented method in accordance with claim 12,
wherein the model-defined user interface comprises a layout of visual components of a purchase checkout interface of the candidate merchant and the components includes one or more of (i) contact information fields, (ii) payment options, and/or (iii) offers presented by the candidate merchant to the candidate cardholder.

16. One or more non-transitory computer-readable storage media with instructions stored thereon that, in response to being executed, cause a computer system for providing a dynamic purchase experience to a candidate cardholder to:
receive current transaction data of the candidate cardholder from a current transaction of the candidate cardholder at a candidate merchant, the candidate merchant being part of a plurality of merchants;
process the current transaction data to generate a plurality of candidate parameters;
retrieve merchant instructions defining a plurality of merchant parameters, the plurality of merchant parameters being associated with a plurality of transaction processes;
compare the plurality of candidate parameters and the plurality of merchant parameters to a plurality of model parameters of a purchase model, the purchase model being specific to and associated with the candidate cardholder;
identify a parameter association between (i) any of the plurality of candidate parameters, (ii) any of the plurality of merchant parameters, and (ii) any of the plurality of model parameters;
generate, based on the parameter association, a set of user interface instructions; and
cause, via a computing device associated with the candidate cardholder, a model-defined user interface relating to the parameter association to be presented to the candidate cardholder during the current transaction via a display screen of the computing device, the model-defined user interface being defined by the user interface instructions.

17. One or more non-transitory computer-readable storage media in accordance with claim 16, wherein the instructions, in response to being executed, further cause the computer system to:
receive purchase activity data of the candidate cardholder, the purchase activity data including purchase data from a plurality of purchases made by the candidate cardholder at the plurality of merchants;
store the purchase activity data in a database associated with the computer system;
process the purchase activity data in accordance with model rules associated with the purchase model;
identify from the purchase activity data a plurality of purchase factors of the candidate cardholder;
create candidate cardholder preference parameters based at least in part on the plurality of purchase factors of the candidate cardholder, wherein the candidate cardholder preference parameters represent a level of preference of the candidate cardholder for at least one aspect of a purchase checkout process; and
train the purchase model with the candidate cardholder preference parameters.

18. One or more non-transitory computer-readable storage media in accordance with claim 17, wherein the instructions, in response to being executed, further cause the computer system to:
update the purchase model with new tracked purchase activity of the candidate cardholder;
generate new candidate cardholder preference information as part of an updated output of the purchase model; and
apply the updated output of the purchase model to analyze a next transaction of the candidate cardholder.

19. One or more non-transitory computer-readable storage media in accordance with claim 16, wherein the model-defined user interface comprises a layout of visual components of a purchase checkout interface of the candidate merchant and the components includes one or more of (i) contact information fields, (ii) payment options, and/or (iii) offers presented by the candidate merchant to the candidate cardholder.

20. One or more non-transitory computer-readable storage media in accordance with claim 19, wherein the offers comprise upsell offers of the candidate merchant associated with a primary item of interest of the candidate cardholder within the purchase checkout interface of the current transaction.
